(19) United States
(12) Patent Application Publication
(10) Pub. No.: US 2004/0153511 A1
(43) Pub. Date: Aug. 5, 2004

(54) Exchanging electronic messages between a host computer system and a distributed computer system

(76) Inventors: Tony Maynard, Cumming, GA (US); David Grosskurth, Austell, GA (US); Paulus Tsang, Peachtree City, GA (US); Mark M. Whitney, Woodland Park, CO (US); Richard Lowell Lawhorn JR., Peachtree City, GA (US); Scott P. Gosline, Duluth, GA (US); Dick Amin, Duluth, GA (US); Gustavo Pina, Atlanta, GA (US); Rajiv Virmani, Smyrna, GA (US)

Correspondence Address: KING & SPALDING LLP, 191 PEACHTREE STREET, N.E., ATLANTA, GA, 30303-1763, US

(21) Appl. No.: 10/038,528

(22) Filed: Jan. 2, 2002

Related U.S. Application Data
(60) Provisional application No. 60/259,477, filed on Jan. 2, 2001.

(51) Int. Cl. G06F 15/16

(52) U.S. Cl. 709/206

(57) ABSTRACT

Exchanging electronic messages between an online transaction processing host computer system and a distributed computer system. This communication exchange encompasses both guaranteed delivery of electronic messages and non-guaranteed delivery of native terminal screen and printer messages, utilizing a message queuing facility. A two-tier architecture is used for all message translations, blocking and reassembling, queuing, acknowledgments and retransmissions, generally reducing necessary message processing and reducing use of system resources.

### PRIORITY AND RELATED APPLICATIONS

The present application claims priority to a provisional patent application entitled, “System and Method for Exchanging Electronic Messages Between a Host Computer System and a Distributed Computer System,” filed on Jan. 2, 2001 and assigned U.S. Application Serial No. 60/259,477.

### TECHNICAL FIELD

The present invention generally relates to exchanging electronic messages, in a defined format, between a host computer system and a distributed computer system. More specifically, the invention supports both the guaranteed delivery and the non-guaranteed delivery of messages between an online transaction processing host system and a distributed computer system using a two-tier architecture and a message queue.

### BACKGROUND OF THE INVENTION

Increased competition in the airline industry is stimulating the development of new applications of information technology, including a new strategic focus on electronic commerce. In addition, airplane travel is becoming an increasingly popular method of travel for people today. This popularity, along with increased competition, has caused the number of airplane travelers to increase dramatically resulting in a greater volume of travelers passing through today's airports. Accordingly, airlines need more efficient ways to handle their travelers, including the wider implementation of electronic commerce applications.

Traditionally, large enterprise computing in the airline industry has relied on using clusters of mainframes running proprietary information systems software. For example, some companies rely on clusters of IBM S/390 mainframe computers running IBM TPF (Transaction Processing Facility or “TPF”) (or even older systems running IBM MVS (Multiple Virtual Storage or “MVS”)), both specialized operating systems. Such traditional online transaction processing systems (“OLTP”) support applications that automate the majority of an airline's operational services. Systems architectures, such as TPF and MVS, have proven to be highly scaleable and available, and these systems have operated successfully over the last thirty years and through the Y2K software “bug” scare.

Despite their reliability and scalability, however, it is difficult to modify these existing OLTP software applications to accommodate a changing industry. Many of the software applications utilized on OLTP systems were developed in assembly language and have evolved over a period of more than thirty years. Originally, these applications were designed to implement specific business models and currently offer little flexibility to support new business models and processes. Specifically, these applications maintain ownership of rigidly defined data sets, and their legacy data formats offer little opportunity for creating new relationships with data from other applications. Additionally, new business models have resulted in the development of new software applications, some of which leverage the Internet. These new business models and new software applications expose the legacy systems to unforeseen transaction types, formats and volumes.

In response to these limitations, a novel strategy has been the addition of distributed computer systems based on newer technology and new software applications. The wealth of information in the existing OLTP systems is harvested by “grabbing” strategic transactions as they occur in “soft real-time”, i.e., substantially real-time. These transactions are then transferred to the distributed computer systems and distributed software applications. In this new environment, the data resulting from the transactions is mapped into alternative evolvable formats and is correlated with previously unrelated information, as well as with information from sources other than the OLTP systems. The immediate correlation stimulates events, which are derived from the transaction histories.

This enables an entirely new class of real-time event-based applications, which have proven to radically improve the efficiency of airline computing operations. The newer distributed computer system, considered in concert with the legacy OLTP system, serves as the basis for constructing new applications and improving airline business operations.

However, the use of a distributed computer system in concert with a legacy OLTP system, is hampered by the fact that current native OLTP host systems standing alone, such as those based on IBM TPF, are only capable of communication with distributed computer systems using either terminal or printer message formats.

These formats are text character data streams where the data is formatted for display on a user's terminal screen or for printing on a terminal printer. If the end user of the data is actually a non-OLTP software application, then it must programmatically parse an OLTP data stream for the critical information it needs utilizing the well-known technique referred to in the art as “screen-scraping”.

This situation is problematic because a software application in the OLTP host and a software application located at an individual workstation or terminal in a distributed computer system must both extract specific data based on its position within a text character data stream. Both applications also must understand a variety of error responses and understand how to respond programmatically to such responses. Providing this type of functionality to each distributed computer application has proven time consuming and inefficient.

An additional problem with this type of conventional art screen-scraping system exists because terminal screen messages are generally limited to the amount of information that is displayable on one mainframe terminal screen. A mainframe terminal screen is normally limited in size to either twelve (12) or twenty-five (25) lines of text by sixty-four (64) columns of text. Larger data transfers in terminal screen message format require multiple message transfers between a host application and distributed applications. Another problem with native IBM TPF communication is that terminal messages are not considered by those skilled in the art to be reliable, as there is no guaranteed messaging protocol between host applications and distributed terminal applications. As a result, distributed applications utilizing terminal messages have been obligated to be designed to provide for message reliability.

One conventional art proprietary system supports improved host/distributed system message communications by addressing some of the problems described above. This system allowed IBM TPF host systems and distributed computer systems to exchange data in any pre-selected format using a reliable, guaranteed, message queuing facility. The pre-selected data format is coordinated between the host system and distributed applications and can be, but is not limited to, structured, delimited text of any character set, structured binary data and/or some combination of these formats and native text terminal data streams. This system also provided a mechanism for exchanging larger messages between the host and distributed applications by breaking larger messages from a sending application into smaller blocks of data for transmission and reassembling the message prior to delivering it to a receiving application.

Because this conventional art system supported new message formats and larger message sizes, it allowed host systems and distributed computer systems to communicate more efficiently, avoided the use of “screen-scraping” and allowed multiple message transfers. In addition, the system supported message queuing and an associated protocol for guaranteed delivery of messages, thereby relieving individual applications of this burden. Thus, a copy of any particular message is held in a message queue at the delivery side of the system until the receiving end of the system sends back an acknowledgment message. If the acknowledgment is received the queued message is deleted. If the acknowledgment is not received, the delivery side of the system resends the queued message.

However, the architecture of this conventional art system requires a gateway process located between the message transmission component located within the host computer system and the message transmission component located on various distributed computers, in order to enable some of its key features. The system gateway is required to accomplish the processes of message blocking and reassembling, message translation and message queuing, and to provide reliable protocols for communication between the host and distributed system environments. Thus, the system gateway, along with the host and the distributed system components, comprises a three-tier architecture for the guaranteed delivery of electronic messages in any defined format between a host system and a distributed computer system. The requirement of the system gateway added an additional component to the system architecture, thereby requiring additional hardware and software components and increased processing of each electronic message within the system gateway. This results in slower system performance, less reliable operation and a less scalable system.

Also, the system gateway process, along with the system program interface for distributed applications, was first created for the IBM personal computer DOS platform and then was migrated to the MICROSOFT WINDOWS operating system and to various UNIX platforms. As a result, these system components were built using less efficient programming techniques that were common to the single tasking nature of the DOS environment. This fact also limited the performance and scalability of this conventional art solution when it migrated to modern computing environments like the MICROSOFT WINDOWS operating system and to various UNIX platforms.

Another conventional art proprietary distributed system programming interface was also developed for use with native terminal and printer data streams in combination with distributed computer systems. The interface was designed to work with the Airline Link Control protocol (“ALC”), which is a full-duplex, synchronous 6-bit protocol that is supported by the industry-standard Programmed Airline Reservation System (“PARS”) and the industry-standard International Programmed Airline Reservation System (“IPARS”). Thus, until now, developers of distributed applications in the airline industry have been forced to choose between utilizing the interface from the first conventional art messaging system noted above or the conventional art ALC program interface. This choice presented a problem for developers as these two interfaces, while having some overlapping functionality, also have some differing functionality.

Consequently, there is a need in the art for a method and system which will further improve communication between OLTP host systems and distributed computer systems over the existing three-tier message systems and the conventional art ALC interface. There is also a need for a system that will encompass both the non-guaranteed delivery of native terminal and printer messaging and delivery in the existing conventional art messaging format through a reliable, guaranteed, message queuing facility. There is also a need for a system that will replace the interface from the first conventional art messaging system and the conventional art ALC program interface so that distributed computer application developers will no longer be forced to choose between two differing messaging interfaces.

There is a further need in the art for a method and system for exchanging electronic messages between a host system and distributed computer systems that utilize modern programming techniques to achieve better performance and greater scalability. Such techniques would include using event-driven mechanisms, versus polling or event loop style logic, and multiplexing multiple communication sessions across a single physical connection between the host and the distributed systems.

Finally, there is a further need in the art for a method and system that eliminates the need for a gateway process between the host and distributed systems so as to more efficiently utilize system resources.

### SUMMARY OF THE INVENTION

The present invention solves the aforementioned problems existing in the conventional art by providing for a method and system for exchanging electronic messages between a host system and distributed computer systems that encompasses both native terminal and printer messaging as well as the conventional art messaging formats. The present invention provides a choice between reliable, guaranteed electronic message delivery via a message queuing facility and non-guaranteed electronic message delivery.

The present invention also can eliminate the need for a gateway process between the host and distributed systems by providing for all message translations, blocking and reassembling, queuing, acknowledgments and retransmissions at the endpoints of the host and distributed systems, generally reducing necessary message processing. As a result, the present invention supports functionality residing within the host system and the distributed system resulting in a novel, two-tier messaging architecture. In addition, the present invention provides functionality that supports both the conventional art three-tier messaging system interface and the ALC interface so that distributed application developers no longer must choose between messaging interfaces.

The present invention can also utilize modern programming techniques which enable it to provide for better performance and greater scalability. As a result, the present invention may allow for better message throughput rates and response times with increased utilization of existing network resources. The programming techniques utilized by the present invention may include using event-driven mechanisms versus polling or event loop style logic and multiplexing multiple communication sessions across a single physical connection between the host and the distributed systems.

The present invention may utilize an online transaction processing host computer system, which includes at least one host computer program application, a distributed computer system, including at least one distributed computer workstation and at least one distributed computer program application, and a communications network connecting the host and distributed computer systems. In addition, the present invention may utilize a host electronic message transmission application, which includes a message queue and a distributed computer electronic message transmission application, which also includes a message queue. The present invention may also utilize a distributed computer program interface, which operates as an interface between the distributed computer electronic message transmission application and the distributed computer program application.

Utilizing the above components, the present invention supports a process for delivering electronic messages between host computer program applications and distributed computer program applications. This process may be initiated by the generation of an electronic message in either a host computer program application or a distributed computer program application.

If the process requires guaranteed delivery and the message is initiated in the host, the message may be passed to the host electronic message transmission application, where it is processed before being transmitted across the communications network to the distributed computer electronic message transmission application, where the message is again processed. In addition, the host transmission application may utilize a message queue which retains a copy of the message until receipt is acknowledged by the distributed computer transmission application. If no acknowledgment is received, the host resends the message until acknowledged. Next, the message is passed to the distributed computer program interface, which in turn passes the message to the distributed computer program application. If the process is initiated in the distributed computer application, the process is merely reversed, with the distributed computer transmission application retaining a copy of the message in its queue.

Where the process does not require guaranteed delivery, the electronic messages may be delivered in terminal screen and/or printer format. In such cases, the host system and distributed systems do not retain copies of the messages after they are sent from their respective transmission applications.

### BRIEF DESCRIPTION OF THE DRAWINGS

FIG. 1 is a functional block diagram illustrating the architecture and components of an exemplary embodiment of the present invention.

FIG. 2 is a logic flow diagram illustrating the interaction and functionality of the architecture and components of the present invention.

FIG. 3 is a logic flow diagram illustrating an exemplary process for exchanging an electronic defined format request message between a distributed computer system application and a host computer system application and for guaranteeing delivery of same.

FIG. 4A is an illustration of the components of an exemplary electronic defined format request or reply message utilized by an exemplary embodiment of the present invention.

FIG. 4B is an illustration of an exemplary data record to be exchanged between a distributed computer system application and an exemplary program interface utilized by an exemplary embodiment of the present invention.

FIG. 4C is an illustration of an exemplary data record to be exchanged between an exemplary program interface and a distributed computer system message transmission application utilized by an exemplary embodiment of the present invention.

FIG. 5 is a functional block diagram illustrating the architecture and components utilized in an electronic defined format request message delivery process carried out by an exemplary embodiment of the present invention.

FIG. 6 is a functional block diagram illustrating the architecture and components utilized in an electronic defined format reply message delivery process carried out by an exemplary embodiment of the present invention.

FIG. 7 is an illustration of the components of an exemplary electronic defined format request or reply data block to be transferred between a host computer system electronic message transmission application and a distributed message transmission application utilized by an exemplary embodiment of the present invention.

FIG. 8 is a logic flow diagram illustrating an exemplary process for exchanging an electronic defined format reply message between a host computer system application and a distributed computer system application and for guaranteeing delivery of same.

FIG. 9 is a logic flow diagram illustrating an exemplary process for exchanging an electronic message request/reply sequence in native terminal screen format between a host computer system application and a distributed computer system application.

FIG. 10 is an illustration of the components of an exemplary electronic terminal screen reply message to be transferred between a host computer system application and a distributed computer system application utilized by an exemplary embodiment of the present invention.

FIG. 11A is an illustration of the components of an exemplary electronic native terminal screen or printer request data block to be transferred between a distributed message transmission application and the host computer system utilized by an exemplary embodiment of the present invention.

FIG. 11B is an illustration of the components of an exemplary electronic terminal screen or printer reply data block to be transferred between a host computer system application a distributed message transmission application utilized by an exemplary embodiment of the present invention.

FIG. 12 is a functional block diagram illustrating the architecture and components utilized in an electronic terminal screen reply message delivery process carried out by an exemplary embodiment of the present invention.

FIG. 13 is an illustration of the components of an exemplary electronic terminal screen or printer request or reply message to be transferred between an exemplary program interface and the distributed computer system application utilized by an exemplary embodiment of the present invention.

FIG. 14 is a logic flow diagram illustrating an exemplary process for exchanging an electronic message in native printer format between a host computer system application and a distributed computer system printer application.

FIG. 15 is an illustration of the components of an exemplary electronic printer reply message to be transferred between a host computer system application and a distributed computer system printer application utilized by an exemplary embodiment of the present invention.

FIG. 16 is a functional block diagram illustrating the architecture and components utilized in an electronic printer reply message delivery process carried out by an alternative exemplary embodiment of the present invention.

FIG. 17 is a functional block diagram depicting the architecture and components of the distributed computer program interface of an exemplary embodiment of the present invention.

FIG. 18 is a flowchart depicting an exemplary process for processing a message received from an application.

FIG. 19 is a block diagram depicting an exemplary peer-to-peer distributed computer network structure.

FIG. 20 is a block diagram depicting an exemplary client-server distributed computer network structure.

FIG. 21 is a block diagram depicting an exemplary wide area client-server distributed computer network structure.

FIG. 22 is a block diagram depicting an exemplary synchronous response requested message processing service.

FIG. 23 is a block diagram depicting an exemplary asynchronous response requested message processing service.

FIG. 24 is a block diagram depicting an exemplary send-and-forget message processing service.

FIG. 25 is a block diagram depicting an exemplary publish-subscribe message processing service.

### DETAILED DESCRIPTION OF THE EXEMPLARY EMBODIMENTS

The present invention provides for improved exchange of electronic messages, in any defined format or in native TPF terminal screen or printer format, between an OLTP host computer system and a distributed computer system. Additionally, it allows guaranteed delivery of defined format messages using a message queuing mechanism. The present invention also provides for non-guaranteed delivery when such result is desirable. In an exemplary embodiment, the present invention provides for the exchange of such messages through a two-tier architecture, which is an improvement over conventional art three-tier systems.

Although the exemplary embodiments described herein include general descriptions of software modules running in a generalized distributed computing environment, those skilled in the art will recognize that the present invention can be implemented in a variety of hardware and software configurations. In a distributed computing environment, program modules may be physically located in different local and remote memory storage devices. Execution of the program modules may occur locally in a stand-alone manner or remotely in a client/server manner. Examples of such distributed computing environments include local area networks of an office, enterprise-wide computer networks, and the global Internet.

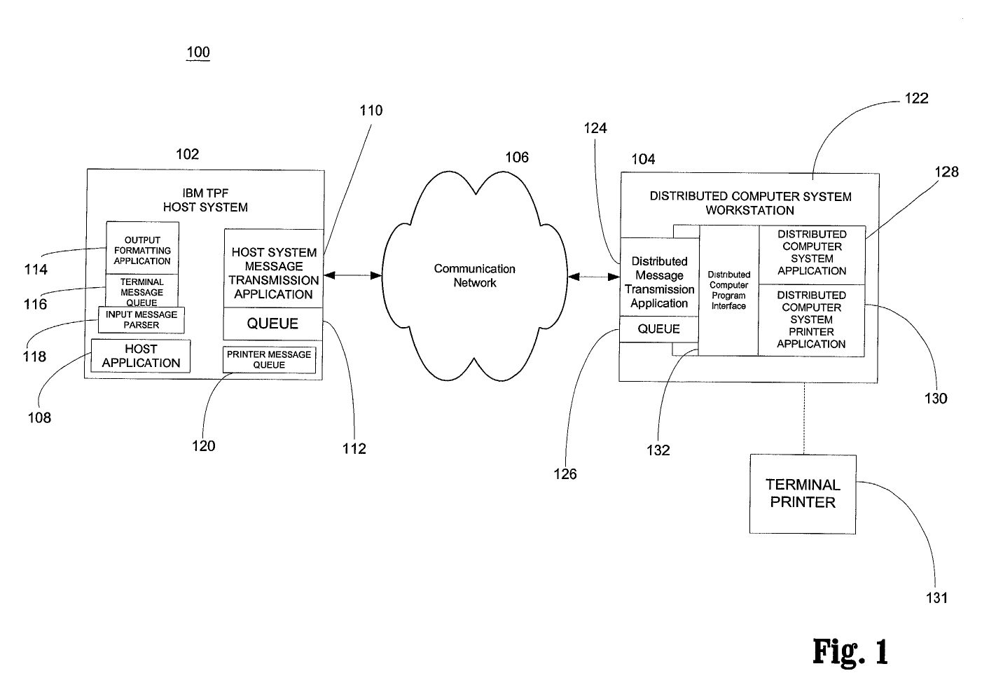

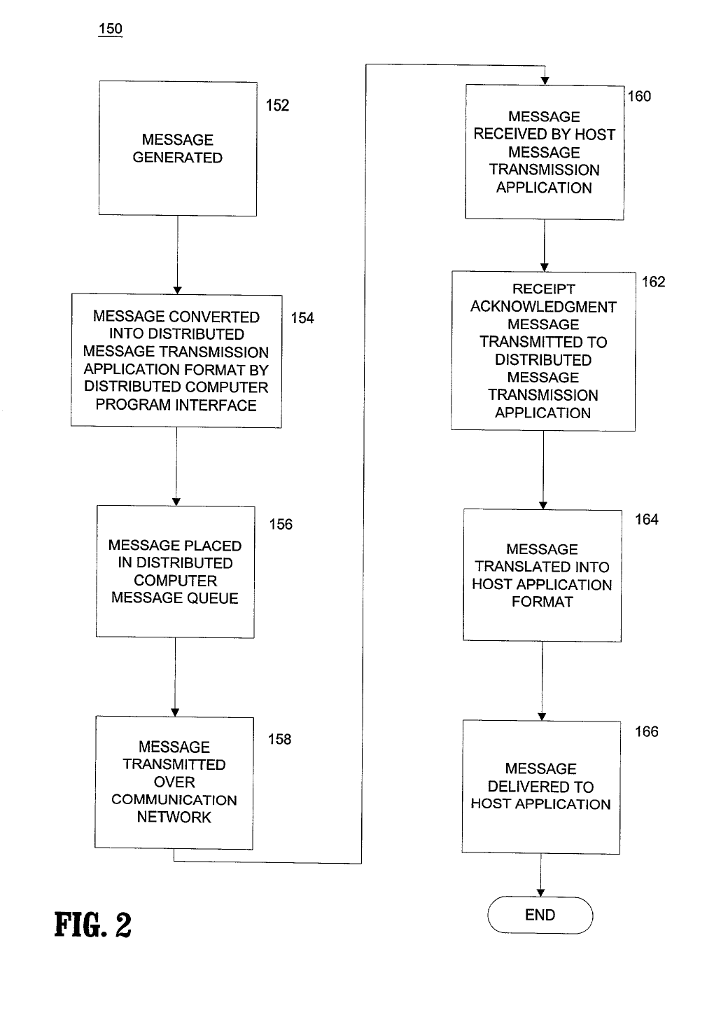

Referring now to the drawings, in which like numerals represent like elements throughout the several figures, aspects of the present invention and the preferred operating environment will be described. FIG. 1 illustrates the architecture and components of an exemplary embodiment of the present invention. In this embodiment, the system 100 comprises a host computer system 102, a distributed computer system 104 and a communications network 106.

The host computer system 102 further comprises at least one host computer program application 108, wherein electronic messages may be generated and/or received for processing. The host computer system 102 also includes a host message transmission application 110, which further comprises a message queue 112 for the purpose of assembling and disassembling messages, converting message formats, message translations, queuing, acknowledgments and retransmissions within the host computer system 102. In addition, the host computer system 102 includes an output formatting application 114, further comprising a message queue 116 and an input message parser 118, both of which provide functionality for the output and input of electronic terminal screen request/reply messages. Also, the host computer system includes a queue 120 for use with the transmission of electronic printer reply messages.

The distributed computer system 104 further comprises at least one distributed computer system workstation 122. The distributed computer workstation 122 includes a distributed message transmission application 124, further comprising a message queue 126, for the purpose of assembling and disassembling messages, converting message formats, message translations, queuing, acknowledgments and retransmissions within the distributed computer system 104. The distributed computer workstation 122 also includes at least one distributed application 128 and a distributed printer application 130, along with a terminal printer 131. In addition, the distributed computer workstation 122 includes a distributed computer program interface 132 for operation between the distributed application 128 and the distributed message transmission application 124.

One of the improvements of the present invention over the conventional art that can be seen in FIG. 1A is the absence of a gateway process contained within the communications network 106 and utilization of the distributed message transmission application 124 within the distributed computer workstation 122. Thus, the present invention comprises a two-tier architecture, i.e., an architecture where the functions of assembling and disassembling messages occur in only two computer program applications 110, 124 within the overall message transfer system as opposed to a three-tier architecture where these functions occur in three computer applications. Specifically, all message translations, blocking and reassembling, queuing, acknowledgments, and retransmissions occur at the origination and termination points for message delivery across the communications network 106. Origination and termination points include the host message transmission application 110 or the input message parser 118 in the host computer system 102 and the distributed message transmission application 124 in the distributed computer system workstation 122. This novel architecture generally reduces by one half the amount of message processing as conventional art systems required message processing both in a gateway process contained within the communication network 106 and through a conventional art distributed computer system message transmission application.

The distributed message transmission application 124 is a separate distributed application and is the messaging endpoint for the distributed computer workstation 122. All electronic request and reply messages that are transferred between any number of other distributed applications 128 and corresponding host applications 108 pass through the distributed message transmission application 124. The distributed message transmission application 124 may be attached to each of the other distributed applications 128 through individual communication connections to multiple instances of the distributed computer program interface 132 built into each distributed application 128.

The distributed message transmission application 124 may also be attached to the communication network 106 through communication connections to communication network connection devices within the communication network 106 that are well known in the art. The communication network connection devices are responsible for concentrating messages from many distributed computer workstations 122 onto higher capacity communication connections to the TPF host computer system 102. The distributed message transmission application 124 may have a number of communication connections to the communication network connection devices as required by the distributed computer workstations 122 for redundancy or load balancing.

The distributed applications 128 may invoke the distributed computer program interface 132 to initiate a messaging session with the host computer system 102 thereby indirectly creating the communication connections to the communication network connection devices noted above. The distributed message transmission application 124 further comprises a messaging queue 126 which stores guaranteed-delivery electronic messages between the distributed application 128 and the host electronic message transmission application 110 for retransmission in the event an electronic message is lost or otherwise unacknowledged by the host computer system 102. The distributed message transmission application 124 also provides functionality for the translation and conversion of native terminal screen and printer messages between the distributed applications 128 and the host applications 108. Translation describes the process of converting ASCII characters to EBCDIC (Extended Binary-Coded Decimal Interchange Code, pronounced eb-sih-dik) in text fields.

EBCDIC is an IBM code for representing characters as numbers. Although it is widely used on large, mainframe IBM computers, most other computers, including MICROSOFT WINDOWS-based PCs and Macintosh computers, use ASCII codes. However, those skilled in the art will appreciate that such translation could occur between any commonly utilized code, like ASCII, and any proprietary code used by OLTP systems. Specifically, in an exemplary embodiment of the present invention, translation describes the process of converting the text characters from ASCII to EBCDIC in electronic request messages from the distributed applications 128 to the host applications 108 and converting the text characters from EBCDIC to ASCII on electronic reply messages from the host applications 108 to the distributed applications 128. Conversion describes the process of reformatting the electronic request messages from the distributed computer format of the distributed application 128 to a native TPF host computer system 102 format and reformatting the electronic reply messages from the native TPF host computer system 102 format to the distributed computer program interface format of the distributed application 128.

Other functionality within the distributed message transmission application 124 supports its electronic messaging functionality and includes the ability to configure the distributed message transmission application 124 from computer files and/or through an electronic interface and the ability to log electronic messaging activity and provide statistics through computer files and/or through an electronic interface.

In addition, this exemplary embodiment utilizes a novel distributed computer program interface 132 to send and receive messages. The distributed computer program interface 132 eliminates the requirement that distributed applications 128 provide for either a conventional art message transmission interface or an ALC interface by providing translation functionality for each type of conventional art format. The distributed computer program interface 132, in combination with the distributed message transmission application 124, also provides the flexibility of sending messages with guaranteed delivery or non-guaranteed delivery. Thus, the present invention can now interact with the host computer system 102 utilizing either non-guaranteed native TPF host terminal or printer messaging and/or guaranteed messaging utilizing defined format messages, each where appropriate.

The functionality of the distributed computer program interface 132 is provided through a set of computer program functions invoked by the distributed applications 128. The program functions “create”, “send”, “sendRequest”, “call”, “subscribe”, “unsubscribe”, “startMonitor”, “stopMonitor”, “isActive”, and “destroy”, and the distributed application 128 program callback function, “handle”, comprise the functionality of the distributed computer program interface 132 and are described herein.

In an exemplary embodiment, the distributed application 128 invokes the “create” program function to initiate a messaging session with the TPF host computer system 102 through the distributed message transmission application 124 and the communication network 106. The details of the messaging session configuration are insulated from the distributed application 128, which simply utilizes a text name to identify the messaging session. The distributed computer program interface 132 utilizes a computer configuration file, located within the distributed computer workstation 122, to reference the configuration details of the messaging session based on the name provided by the distributed application 128. The configuration details of the messaging session include information pertaining to the specific host resource utilized during the messaging session, including whether the messaging session is a native TPF host computer system 102 terminal or printer session, how the host portion of the messaging session maps to a communication network 106 resource and/or details on creating communication connections between the distributed computer program interface 132 and the distributed message transmission application 124, and also between the communication network connection device and the distributed message transmission application 124.

Native TPF host computer system terminal messaging sessions can be utilized for either native terminal screen request and reply messages or for defined format request and reply messages. The defined format request and reply messages are identified to the TPF host computer system 102 and the distributed message transmission application 124 by the presence of a special indicator on the front of each defined format request or reply message.

The distributed application 128, after preparing a request message, may invoke various program functions, including a “send,” “sendRequest,” or “call” program function to send the message to the host application 108 through the distributed message transmission application 124. The “send” program function is utilized by the distributed application 128 to send one-way messages to the host application 108 where no reply message is expected. The “sendRequest” and “call” program functions are utilized by the distributed application 128 to send request messages to the host application 108 where a reply message is expected. The “sendRequest” and “call” program functions differ in their interaction with the distributed application 128. Specifically, the “sendRequest” program function is an asynchronous function whereby the distributed application 128 provides a program callback function, “handle,” which is invoked by the distributed computer program interface 132 to deliver the reply message after receiving it from the host application 108. The asynchronous nature of the “sendRequest” program function provides a mechanism for the distributed application 128 to send a request message, immediately continue processing other tasks, and be notified by the distributed computer program interface 132, through invocation of the distributed application 128 “handle” program function, when the reply message is received from the host application 108.

The “call” program function is a synchronous function. When the “call” program function is invoked by the distributed application 128, the distributed application 128 simultaneously provides a request message and an uninitialized reference to a memory buffer within the distributed computer workstation 122 for a corresponding reply message. Thereafter, the distributed computer program interface 132 will return to the memory buffer reference a memory address for the corresponding reply message before returning from the “call” program function to the distributed application 128. The synchronous nature of the “call” program function provides a mechanism for the distributed application 128 to send a request message and receive a reply message through one invocation of the distributed computer program interface 132 without utilizing the “handle” program callback function.

The “subscribe” program function of the distributed computer program interface 132 is utilized by the distributed application 128 to enable receipt of one-way messages from host applications 108 through a “handle” program callback function provided by the distributed application 128 when invoking the “subscribe” program function. Such a message is delivered and the distributed application 128 notified by the distributed computer program interface 132, through invocation of the distributed application 128 “handle” program function, when a one-way message is received from the host application 108. The distributed application 128 may invoke the “subscribe” program function multiple times to enable receipt of defined format messages, native terminal screen messages, and/or native printer messages. The “unsubscribe” program function is utilized by the distributed application 128 to disable receipt of one-way messages from host applications 108.

The “startMonitor” and “stopMonitor” program functions of the distributed computer program interface 132 are utilized by the distributed application 128 to enable and disable receipt of distributed computer program interface 132 status messages through a “handle” program callback function provided by the distributed application 128 when invoking the “startMonitor” program function. Such status messages are delivered by and the distributed application 128 is notified by the distributed computer program interface 132, through invocation of the distributed application 128 “handle” program callback function, when the status of the communication connection between the distributed computer program interface 132 and the distributed message transmission application 124 changes. Such status messages inform the distributed application 128 whether the communication connection between the distributed message transmission application 124 and the distributed computer program interface 132 is operational or not and provides the distributed application 128 a mechanism for notification of the current status.

The “isActive” program function is a more direct mechanism for the distributed application 128 to obtain status information regarding the communication connection between the distributed message transmission application 124 and the distributed computer program interface 132 because it provides no notification other than the simple return of a true indication if the communication connection is operational or a false indication if the communication connection is not operational.

The “destroy” program function of the distributed computer program interface 132 is utilized by the distributed application 128 to end a messaging session with the TPF host computer system 102.

In an exemplary embodiment of the present invention, the distributed message transmission application 124 and the distributed computer program interface 132 both utilize modern programming techniques which enable better performance and greater scalability than conventional art systems. One such programming improvement utilized by both the distributed message transmission application 124 and the distributed computer program interface 132 is the use of “event-driven” mechanisms available on modern computer system platforms. An example of an event-driven mechanism is an operating system notification (or “callback” function) to a computer program when a certain event has occurred, such as the expiration of a timer or the arrival of a message from a communication connection, allowing an application to remain dormant until the event occurs.

Conventional art systems were originally developed for use with the IBM personal computer DOS platform, which did not provide typical event-driven mechanisms. As such, conventional art systems required a constantly-executed program event loop to determine if a timer had expired, if there were messages to send or receive, or if there were other tasks to be performed. Thus, conventional art systems constantly occupy distributed computer processing time that could be utilized by other computer programs when conventional art systems actually had no messaging work to perform. The MICROSOFT WINDOWS operating system and various UNIX-based operating systems utilized by exemplary embodiments of the present invention provide event-driven mechanisms such that the distributed message transmission application 124 and the distributed computer program interface 132 are notified by the operating system when there is messaging work to be performed, making the present invention more efficient than conventional art systems. Further, event loop-style logic is not utilized in either the distributed message transmission application 124 or the distributed computer program interface 132, which would unnecessarily occupy distributed computer processing time. All functional processes within both components are driven by notifications or program callback functions from the distributed computer workstation's operating system, resulting in increased computer processing capacity within the distributed computer workstation 122.

Another modern programming technique utilized by exemplary embodiments of the distributed message transmission application 124 of the present invention is multiplexing of multiple distributed application messaging sessions with the TPF host computer system 102 across a single communication connection between the distributed message transmission application 124 and devices within the communication network 106. Conventional art systems were typically required to create one communication connection for each distributed computer system application/host messaging session. As a result of using multiple communication connections between the distributed computer workstations 122 and the communication network 106 devices, such communication network connection devices supported far less distributed computer workstations 122, which required the use of additional communication network connection devices within the communication network 106 resulting in increased expense for the operation of conventional art systems. In contrast, the distributed message transmission application 124 maintains only one communication connection to any single communication network connection device within the communication network 106 for all host computer system messaging sessions associated with that single device from all distributed computer system applications 128 within a given distributed computer workstation 122.

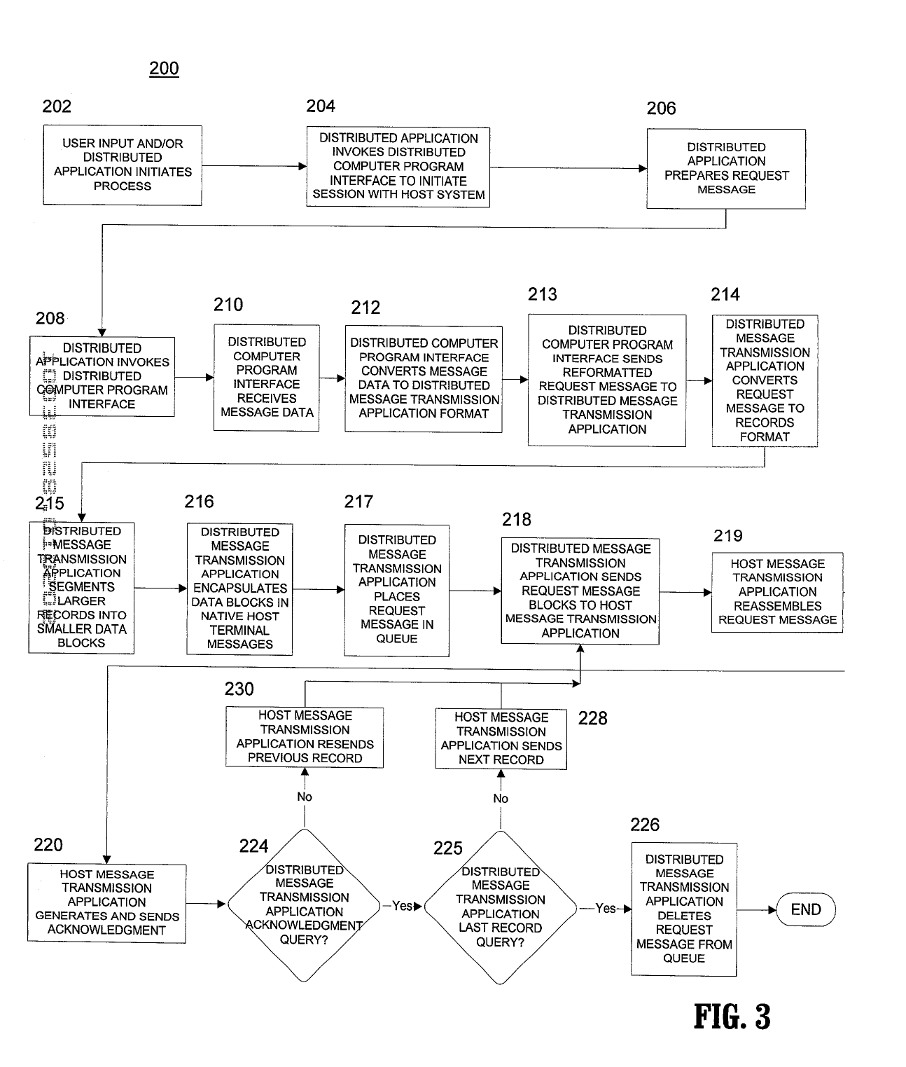

FIG. 3 is a logic flow diagram of an exemplary process 150 that illustrates the interaction and functionality of the architecture and components of the present invention. In step 152, an electronic message is generated in the distributed application 128 operating within the distributed computer system 104. In step 154, a copy of the electronic message is converted into an acceptable format for transfer to the distributed message transmission application 124 by the distributed computer program interface 132. In step 156, a copy of the electronic message is placed in a message queue 126 by the distributed message transmission application 124. In step 158, the electronic message is transmitted over the communications network 106 between the distributed application 128 and the host application 108 by way of the distributed message transmission application 124. In step 160, the electronic message is received by the host message transmission application 110. In step 162, an electronic receipt acknowledgment message is transmitted to the distributed message transmission application 124. In step 164, the electronic message is translated into a pre-selected host application format. In step 166, the electronic message is delivered to the host application 108.

FIG. 3 is a logic flow diagram illustrating an exemplary process 200 for exchanging an electronic defined format request message between a distributed application 128 and a host application 108 and for guaranteeing delivery of same. Although several of the exemplary processes described herein relate to request/reply messages, those skilled in the art will appreciate that details of a request from the distributed application 128 to the host application 108 and a reply from the host application 108 to the distributed application 128 each also represent the process and message flow for one-way messaging in each direction.

In step 202, the distributed application 128 initiates the exemplary process 200 when either a system user or the distributed application 128 initiates an action which requires information to be exchanged between the host application 108 and the distributed application 128, necessitating a request/reply interaction between the distributed application 128 and the host application 108.

In step 204, the distributed application 128 invokes the novel distributed computer program interface 132, utilizing the “create” program function, to initiate a messaging session with the TPF host computer system 102. The distributed application 128 specifies a text-based session name in the “create” program function, which is then utilized by the distributed computer program interface 132 to access a configuration file, located within the distributed computer workstation 122, with configuration details about the host messaging session. The configuration details of the host messaging session include information pertaining to the specific host resource such as a designation for a native TPF host computer system 102 terminal messaging session, how the session maps to a communication network resource, and details on creating communication connections between the distributed computer program interface 132 and the distributed message transmission application 124, and also between the communication network connection device and the distributed message transmission application 124. Alternatively, the host messaging session could be initiated during startup of the distributed application 128 or at some other appropriate time. Once initiated, the host messaging session may be maintained for the duration of the execution of the distributed application 128 or only for a series of message transfers. In addition, the availability of a host messaging session may be provided exclusively for the distributed application 128 or allocated from a pool of host sessions available for use by any distributed application 128 within the distributed computer workstation 122. In step 206, the distributed application 128 prepares a request message to obtain information from the host application 108 using data input by the user or generated by the distributed application 128.

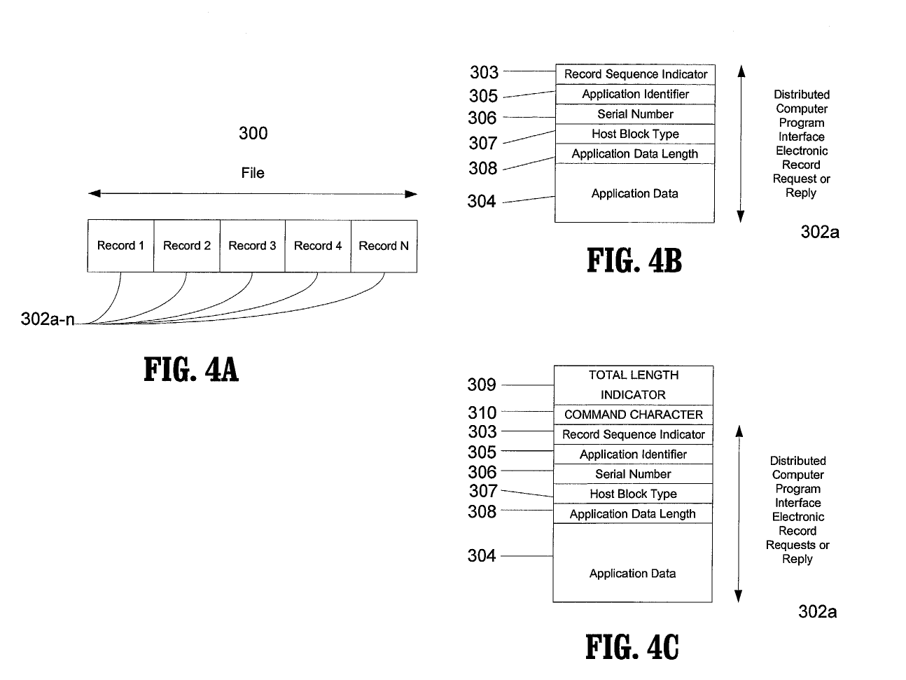

As shown in FIG. 4A, the amount of data comprising a defined format request or reply message can be of any size and is represented logically as a data file 300 with one or more records 302a-n, although most request messages in the request/reply model will only comprise one record. As shown in FIG. 4B, each of the individual records 302a-n, or alternatively the complete data file 300, presented to the distributed computer program interface 132 contain relevant application data 304 from the distributed application 128 along with a record sequence indicator 303, an application identifier 305, a serial number 306 to uniquely identify the request, a host block type identifier 307, and an application data length indicator 308. The distributed application data 304 is typically represented by any combination of ASCII characters and binary data fields. The application and host block type identifiers 305, 307 are values previously agreed upon by both the sending and receiving applications to identify the request message content, i.e., data block size and format, and to identify the appropriate host and distributed applications 108, 128 for message routing. The record sequence indicator 303 indicates “first,” “middle,” “last,” and/or “only” records of a request message 300. Larger messages may have more than one record with a “middle” record sequence indicator 303. The serial number 306 provides a way for the sending application to match up a reply message 300 with its corresponding request message 300. The application data length indicator 308 contains the number of characters within the application data 304. The distributed application 128 can create message records 302a-n as a stream of data characters including the identifying attributes 303, 305, 306, 307, 308 and the distributed application data 304. In the alternative, message records 302a-n can be created by using functionality provided by the distributed computer program interface 132. For this alternative embodiment, the distributed application 128 simply provides the distributed application data 304 and the identifying attributes 303, 305, 306, 307, and 308 to the distributed computer program interface 132 as separate pieces of data.

Returning to FIG. 3, in step 208, the distributed application 128 again invokes the distributed computer program interface 132, utilizing either the “send,” “sendRequest,” or “call” program functions, in order to send the complete request message 300, or alternatively, each record 302a-n of a request message 300 to the host computer system 102 and subsequently to a host application 108. In step 210, the distributed computer program interface 132 receives message data from the distributed application 128. In step 212, the distributed computer program interface 132 converts the message data into a format acceptable to the distributed message transmission application 124.

As seen in FIG. 4C, the conversion step involves adding a command character 310 to the front of the request message, which informs the distributed message transmission application 124 that this is a defined format request message, and adding a total length indicator 309 to the front of the request message to represent the total length of the transmission to the distributed message transmission application 124.

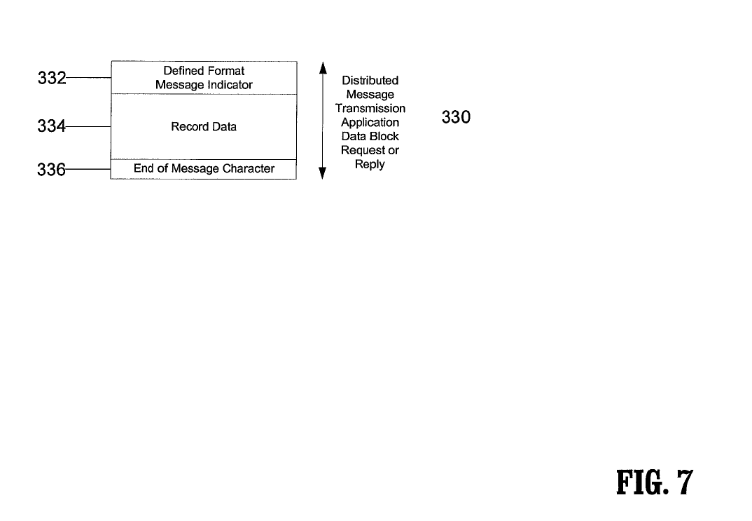

Returning to FIG. 3, in step 213, the distributed computer program interface 132 sends the reformatted request message to the distributed message transmission application 124. In step 214, the distributed message transmission application 124 converts request messages 300 that are larger than the maximum record size into a number of records 302a-n. In step 215, the distributed message transmission application 124 segments larger records 302a-n into multiple data blocks if the individual record size exceeds the maximum transmission block size on the communication network 106. In step 216, the distributed message transmission application 124 encapsulates each data block in a native TPF host terminal data block 330, as shown in FIG. 7, by adding a defined format message indicator 332 at the front of each data block and an end-of message character 336 at the end of each data block. In step 217, the distributed message transmission application 124 places the converted request message 300 into the queue 126. In step 218, the distributed message transmission application 124 begins sending a copy of the data blocks stored in the queue 126 to the host message transmission application 110. In step 219, the host message transmission application 110 removes the data blocks added in step 216 from the native TPF host terminal data block format, reassembles each of the data blocks into a record 302a-n and prepares to pass them to the appropriate host system application 108.

In step 220, the host message transmission application 110, upon receipt of a complete record 302a-n, generates and sends an acknowledgment message to the distributed message transmission application 124. In step 224, the distributed message transmission application 124 queries whether it has received an acknowledgment message from the host message transmission application 110. If so, in step 225 the distributed message transmission application 124 queries whether the “last” record 302a-n of the request message 300 has been transmitted successfully by looking for a “last” record sequence indicator 303. If a “last” record sequence indicator 303 is located, in step 226 the distributed message transmission application 124 deletes the request message 300 from the queue 126. If a “last” record sequence indicator is not located, in step 228 the exemplary process 200 then repeats the tasks in steps 218, 219, 220 for each subsequent record 302a-n until all records have been transmitted. If, in step 224, no acknowledgment is received for any given record 302a-n, in step 230 the process 200 again returns to step 218 and the distributed message transmission application 124 resends the unacknowledged record to the host message transmission application 110.

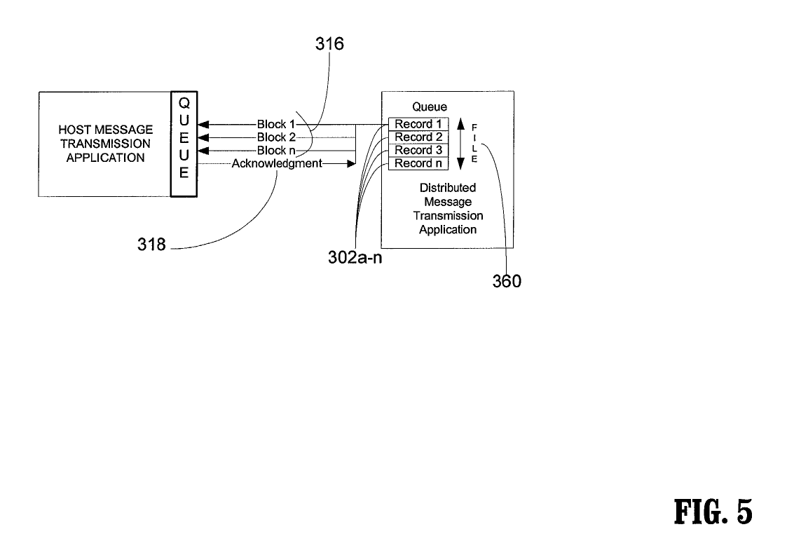

FIG. 5 is a block diagram of the request message transfer process between the distributed message transmission application 124 and the host message transmission application 110. In this instance, the distributed message transmission application 124 has already received a request message 300 from the distributed computer program interface 132 consisting of a number of records 302a-n that have been stored in the queue 126. The distributed message transmission application 124 then disassembles the “first” record 302a into a number of data blocks 316, which are transmitted over the communications network 106 to the host message transmission application 110. As noted above, a record 302a-n is segmented into smaller data blocks 316 when the record size exceeds the maximum transmission block size of the communication network 106. Once the host message transmission application 110 has received and reassembled the data blocks 316 into a complete record 302a-n, and placed the record into the queue 112, the host message transmission application 110 generates and sends an acknowledgment message 318 to the distributed message transmission application 124. If the acknowledgment message 318 is not received by the distributed message transmission application 124, the relevant record 302a-n is retransmitted to the host message transmission application 110. The process is repeated for each record 302a-n of the request message 300. Once all the records 302a-n are delivered successfully, the distributed message transmission application 124 deletes the request message 300 from the queue 126.

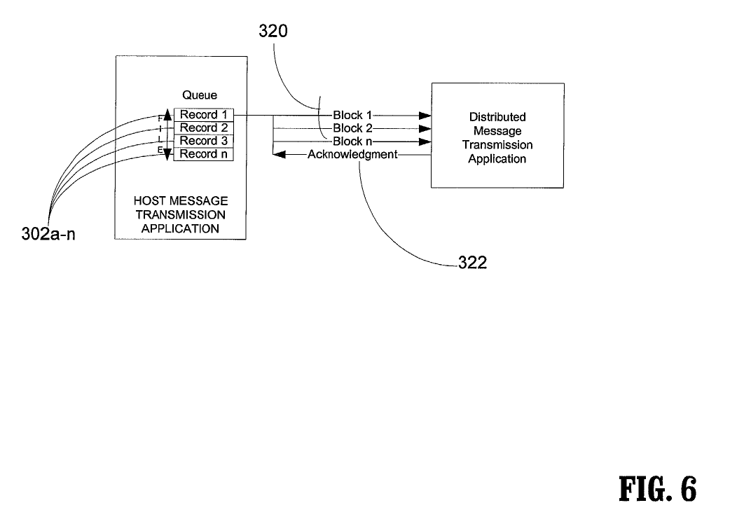

FIG. 6 is a block diagram illustration of the reply message transfer process between the host message transmission application 110 and the distributed message transmission application 124. In this instance, the host message transmission application 110 has already received a reply message 300 from a host application 108 consisting of a number of records 302a-n that have been stored in the queue 112. The host message transmission application 110 then disassembles the “first” record 302a into a number of data blocks 320, which are transmitted over the communications network 106 to the distributed message transmission application 124. As noted above, a record 302a-n is segmented into smaller data blocks 320 when the record size exceeds the maximum transmission block size of the communication network 106. Once the distributed message transmission application 124 has received and reassembled the data blocks 320 into a complete record 302a-n, and placed the record in the queue 126, the distributed message transmission application 124 generates and sends an acknowledgment message 322 to the host message transmission application 110. If the acknowledgment message 322 is not received by the host message transmission application 110, the record 302a-n is retransmitted to the distributed message transmission application 124. The process is repeated for each record 302a-n of the request message 300. Once all the records 302a-n are delivered successfully, the host transmission application 110 deletes the request message 300 from the queue 112.

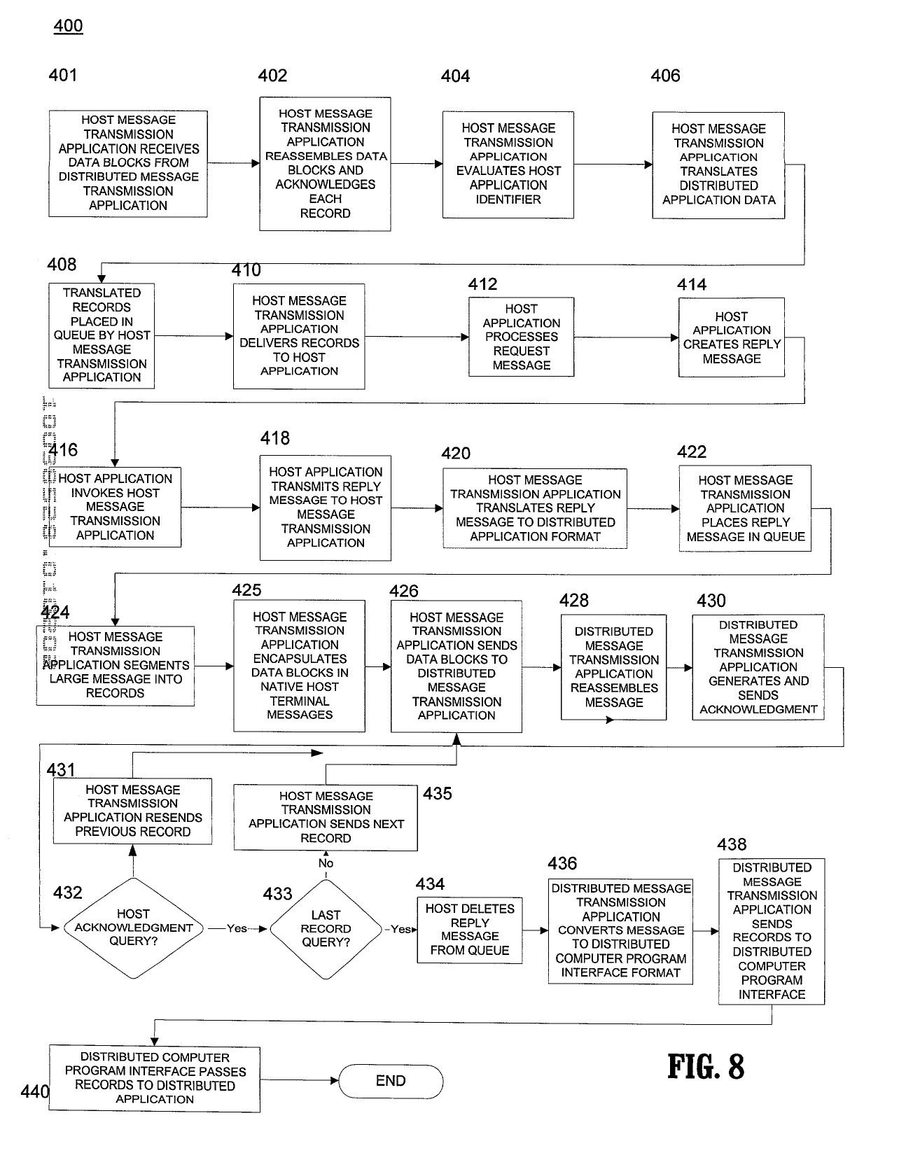

FIG. 8 is a logic flow diagram illustrating an exemplary process for exchanging an electronic defined format reply message between a host computer system 102 and a distributed computer system application 104 and for guaranteeing delivery of same. In step 401, the host message transmission application 110 receives data blocks 330 from the distributed message transmission application 124. In step 402, the host message transmission application 110 reassembles the data blocks 330 into individual records 302a-n and acknowledges each record to the distributed message transmission application 124. In step 404, the host message transmission application 110 evaluates the host application identifier 305 to determine the identity of the relevant host application 108.

In step 406, the host message transmission application 110 translates the distributed application data 304 into a format usable by the relevant host application 108. This translation normally involves translation of ASCII characters to EBCDIC (Extended Binary-Coded Decimal Interchange Code, pronounced eb-sih-dik) in text fields. EBCDIC is an IBM code for representing characters as numbers. Although it is widely used on large, mainframe IBM computers, most other computers, including MICROSOFT WINDOWS-based PCs and Macintosh computers, use ASCII codes. However, those skilled in the art will appreciate that such translation could occur between any commonly utilized code, like ASCII, and any proprietary code used by OLTP systems. In addition, this translation normally requires swapping the order of multiple character binary fields if the host computer system 102 and the distributed application 128 store binary data differently.

In step 408, the translated records 302a-n are placed in the queue 112. In step 410, the host message transmission application 110 begins delivering the records 302a-n to the relevant host application 108 based upon the host message transmission application's analysis of the host application identifier 305.

In step 412, after receiving the complete request message 300, the relevant host application 108 processes the request message 300. In step 414, the relevant host application 108 creates a reply message for transmission to the distributed application 128. In step 416, the relevant host application 108 invokes the host message transmission application 110 to handle transmission of the reply message 300. In step 418, the relevant host application 108 transmits the reply message to the host message transmission application 110. In step 420, the host message transmission application 110 translates the reply message 300 into the format required by the distributed application 128. In step 422, the host message transmission application 110 places the translated reply message 300 into the queue 112. The reply message 300 will normally comprise multiple records 302a-n, each containing host application data 304, the record sequence indicator 303, the distributed application identifier 305, the serial number 306 and the application data length 308.

In step 424, after queuing the records 302a-n, the host message transmission application 110 segments larger records into multiple, smaller data blocks 330 when the record size exceeds the maximum transmission block size of the communication network 106. In step 425, the host message transmission application 110 encapsulates each of the data blocks in a native TPF host terminal data block, as shown in FIG. 7, by adding a defined format message indicator 332 at the front of each of the data blocks and an end-of-message character 336 at the end of each of the data blocks. In step 426, the host message transmission application 110 begins sending the data blocks 330 sequentially to the distributed message transmission application 124. In step 428, the distributed message transmission application 124 removes each of the data blocks added in step 425 from the native TPF host terminal data block format, reassembles the data blocks 330 into a record 302a-n, and places the record 302a-n into the queue 126. In step 430, the distributed message transmission application 124, upon receipt of a complete record 302a-n, generates and sends an acknowledgment message to the host message transmission application 110.

In step 432, the host message transmission application 110 queries whether it has received an acknowledgment message from the distributed message transmission application 124. If so, in step 433 the host message transmission application 110 queries whether the “last” record 302a-n of the reply message 300 has been transmitted successfully by looking for a “last” record sequence indicator 303. If a “last” record sequence indicator is located, in step 436 the host message transmission application 110 deletes the reply message 300 from the queue 112. If a “last” record sequence indicator 303 is not located, in step 435 the exemplary process 400 then repeats the tasks in steps 426, 428, and 430 for each subsequent record 302a-n until all records have been transmitted. If, in step 432, no acknowledgment is received for any given record 302a-n, in step 431 the process 400 again returns to step 426 and the host message transmission application 110 resends the unacknowledged record to the distributed message transmission application 124.

In step 436, the distributed message transmission application 124 converts the reply message into a format acceptable to the distributed computer program interface 132. The conversion step involves adding a command character 310 to the front of the message, which informs the distributed computer program interface 132 that this is a defined format reply message, and adding a total length indicator 309 to the front of the request message to represent the total length of the transmission to the distributed computer program interface 132. In step 438, the distributed message transmission application 124 sends each record 302a-n of the reply message 300 to the distributed computer program interface 132. In step 440, the distributed computer program interface 132 passes each of the records 302a-n of the reply message 300 to the distributed application 128. The records 302a-n are passed to the application by completion of the distributed computer program interface 132 “call” program function or through the handle program callback function of the distributed application 128 utilized with the “sendRequest” or “subscribe” program functions. Once each of the records 302a-n of the reply message 300 has been delivered to the distributed application 128, the exemplary process 400 ends.

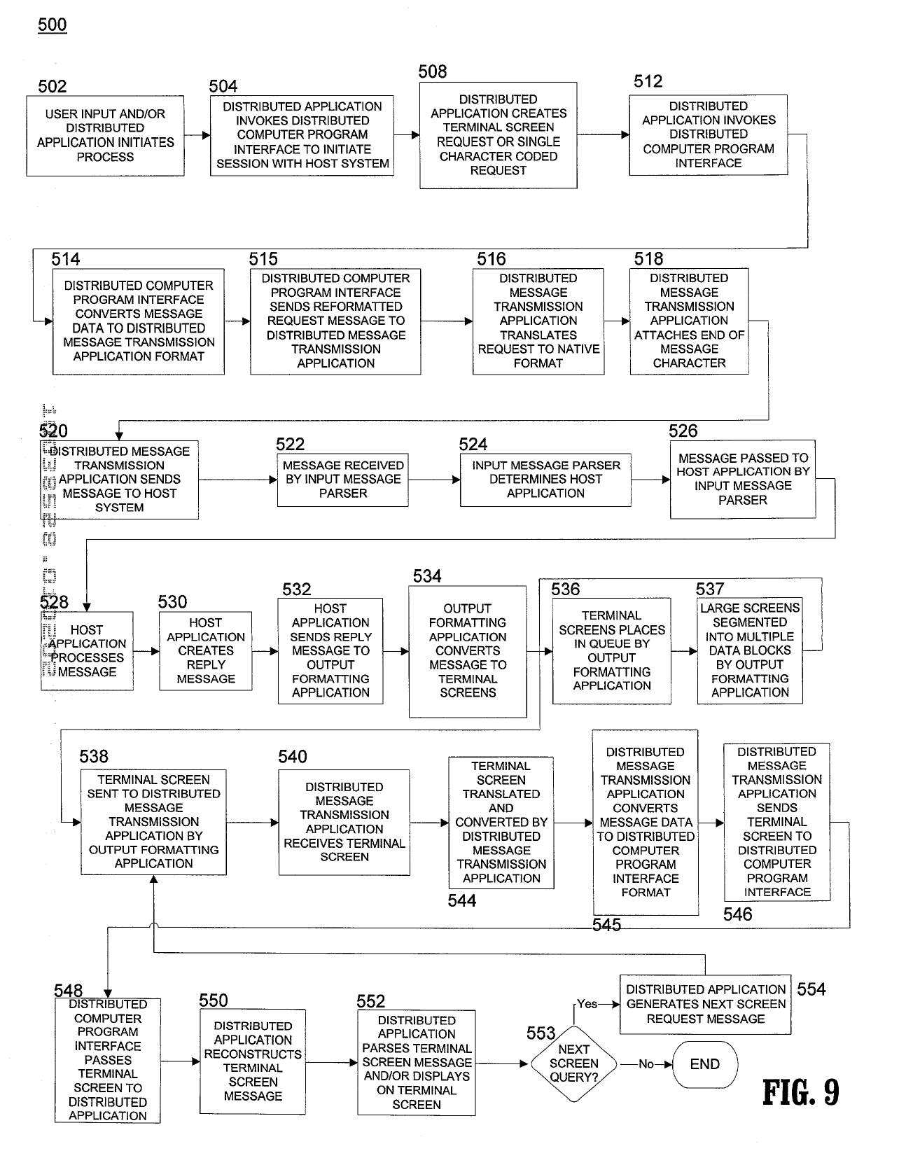

FIG. 9 is a logic flow diagram illustrating an exemplary process 500 for exchanging an electronic request/reply message sequence in native terminal screen format between a distributed computer system application 128 and a host computer system 102 without guaranteeing delivery of same. Although several of the exemplary processes described herein relate to request/reply messages, those skilled in the art will appreciate that details of a request from the distributed application 128 to the host application 108 and a reply from the host application 108 to the distributed application 128 each also represent the process and message flow for one-way messaging in each direction.

In step 502, the distributed application 128 initiates the exemplary process 500 when either a system user or the distributed application 128 initiates an action which requires information to be exchanged between the distributed application 128 and the host application 108, necessitating a request/reply interaction between the distributed application 128 and the host application 108. In step 504, the distributed application 128 invokes the distributed computer program interface 132, utilizing the “create” program function, to initiate a messaging session with the TPF host computer system 102. The distributed application 128 specifies a text-based session name in the “create” program function, which the distributed computer program interface 132 utilizes to access a configuration file, located within the distributed computer workstation 122, with configuration details about the host messaging session. The configuration details of the host messaging session include information pertaining to the specific host resource such as a designation for a native TPF host computer system 102 terminal messaging session, how the session maps to a communication network resource, and details on creating communication connections between the distributed computer program interface 132 and the distributed message transmission application 124, and also between a communication network connection device and the distributed message transmission application 124. Alternatively, the host messaging session could be initiated during startup of the distributed application 128 or at some other appropriate time. Once initiated, the host session may be maintained for the duration of the execution of the distributed application 128 or only for a series of message transfers. In addition, the availability of a host messaging session may be provided exclusively for the distributed application 128 or allocated from a pool of host messaging sessions available for use by any distributed application 128 within the distributed computer workstation 122.

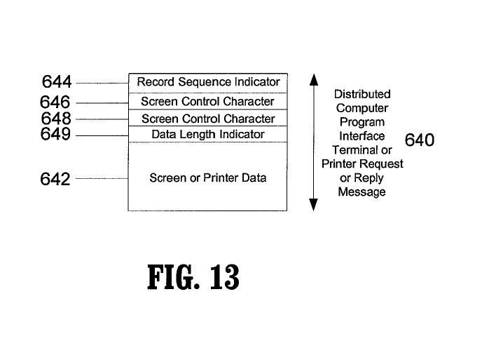

In step 508, the distributed application 128 prepares a request message 640, as seen in FIG. 13, to obtain information from the host application 108 using data input by the user or generated by the distributed application 128. In this exemplary process 500, the request message 640 may either be a terminal screen of data (generally up to 12 lines of characters by 65 columns of characters or 768 total characters) or a special type of coded request consisting of a single character. As seen in FIG. 13, both types of request messages consist of a single message containing a record sequence indicator 644, terminal screen data 642, and an application data length indicator 649. Screen control characters 646, 648 are not utilized for request messages. A record sequence indicator 644 for terminal screen messages is always the “only” indicator as terminal screen request messages are limited to a single message. The record sequence indicator 644 for the coded request message is always the “middle” indicator as required by the host application 108 that processes these types of requests. The data for both request types is ASCII text characters.

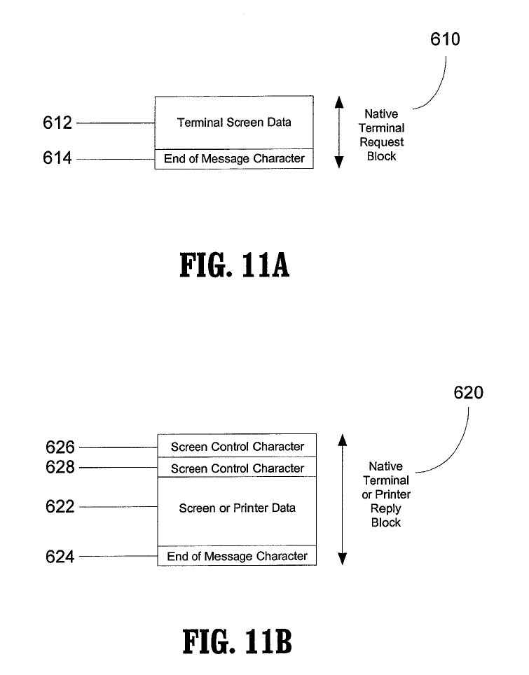

In step 512, the distributed application 128 again invokes the distributed computer program interface 132, utilizing either the “send,” “sendRequest” or “call” program functions, in order to send the terminal screen request message 640 to the distributed computer program interface 132. In step 514, the distributed computer program interface 132 converts the request message 640 into a format acceptable to the distributed message transmission application 124. The conversion step involves adding a command character 310 to the front of the request message, which informs the distributed message transmission application 124 that the request message is a native terminal request message, and adding a total length indicator 309 to the front of the request message to represent the total length of the transmission to the distributed message transmission application 124. In step 515, the distributed computer program interface 132 sends the reformatted request message to the distributed message transmission application 124. In step 516, the distributed message transmission application 124 translates the request message from ASCII to EBCDIC characters, i.e., into native TPF host system format. In step 518, the distributed message transmission application 124 forms the native TPF host terminal request data block 610, as shown in FIG. 11A, by converting the record sequence indicator 644 into an end of message character 614. In step 520, the distributed message transmission application 124 sends the native terminal screen request data block 610 over the communication network 106 to the host computer system 102 for processing. In step 522, the host computer system 102 receives the data block 610 into an input message parser 118. In step 524, the input message parser 118 evaluates the content of the data block 610 and determines the relevant host application 108 to which the data block 610 is to be sent. In step 526, the input message parser 118 passes the native terminal data block 610 to the relevant host application 108.

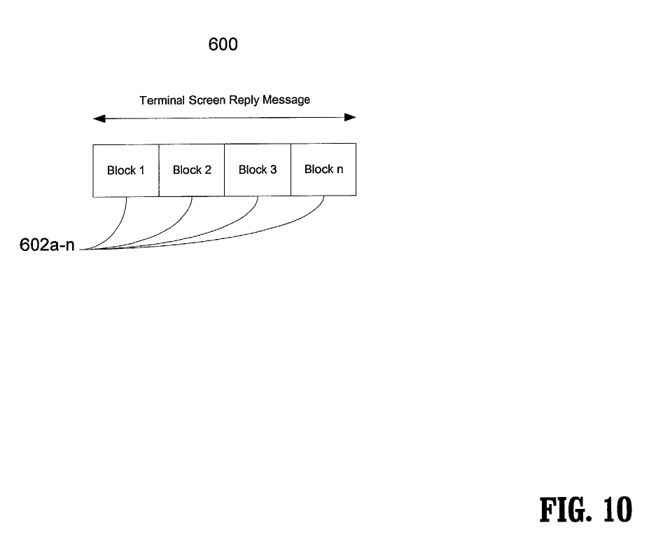

In step 528, the relevant host application 108 processes the native terminal request data block 610. In step 530, the relevant host application 108 creates a native terminal screen reply message. In step 532, the relevant host application 108 sends the reply message to an output formatting application 114. In step 534, the output formatting application 114 converts the reply message into a series of terminal screens of data (generally up to 12 lines of characters by 65 columns of characters or 768 total characters) as shown in FIG. 10. In step 536, the output formatting application 114 places the series of terminal screens into the terminal message queue 116. In step 537, the output formatting application 114 segments larger screen replies into multiple data blocks 620 if the screen size exceeds the maximum transmission block size on the communication network 106. In step 538, the output formatting application 114 begins sending the data blocks associated with the first of the series of terminal screens to the distributed message transmission application 124 across the communications network 106.

In step 540, the distributed message transmission application 124 receives each of the data blocks comprising the terminal screen reply message 600. In step 544, the distributed message transmission application 124 translates the EBCDIC terminal screen message data 622 to ASCII format and converts the end of message character 624 to a record sequence indicator 644. The record sequence indicator 644 indicates “middle” or “last” and/or “only” data block of the distributed computer reply message 640. The “first” record sequence indicator 303 is not utilized with native terminal screen reply messages. In step 545, the distributed message transmission application 124 converts the message into a format acceptable to the distributed computer program interface 132. The conversion step involves adding a command character 310 to the front of each of the data blocks, which informs the distributed computer program interface 132 that the reply message is a native terminal screen reply message, and adding a total length indicator 309 to the front of the request message to represent the total length of the transmission to the distributed computer program interface 132. In step 546, the distributed message transmission application 124 sends the reformatted terminal screen reply message data blocks 620 to the distributed computer program interface 132. In step 548, the distributed computer program interface 132 passes the terminal screen reply messages 640 to the distributed application 128. The reply messages are passed to the application by completion of the distributed computer program interface 132 “call” program function or through the “handle” program callback function of the distributed application 128 utilized with the “sendRequest” or “subscribe” program functions. In step 550, the distributed application 128 utilizes the record sequence indicator 644 to reconstruct the messages to form a complete terminal screen reply message 600. In step 552, the distributed application 128 either parses the data for further use by the user or the application or, if displaying the information onto a terminal screen, uses the screen control characters 646, 648 to determine screen placement and behavior. In step 553, the distributed application 128 queries, upon request by the user or by decision within the distributed application 128, whether additional terminal screen messages 600 are to be requested. In step 554, the distributed application 128 generates an additional request message which is routed to the output formatting application 114 through the distributed computer program interface 132 and the distributed message transmission application 124 to request the next terminal screen reply message be sent from the output formatting application 114 to the distributed application 128. The exemplary process 500 then returns to step 538 and repeats the process steps until all terminal screen reply messages 600 have been transmitted to the distributed application 128.

FIG. 10 illustrates a terminal screen reply message 600, which may consist of a number of native TPF host terminal screen data blocks 602a-n.

FIG. 11A illustrates a native terminal screen request data block 610 between the distributed message transmission application 124 and the host computer system 102. A terminal screen request message from a distributed application 128 is limited to the size of one native terminal screen data block 610 and consists of the terminal screen data 612 represented as ASCII characters and an end of message character 614 which indicates either “middle” or “last” and/or “only” message of a request.

FIG. 11B illustrates a native terminal screen or printer reply data block 620 between a host computer system 102 and the distributed message transmission application 124. The terminal screen reply data blocks 620 or printer reply data blocks 620 consist of the terminal screen or printer data 622 represented as EBCDIC characters, an end of message character 624, and two screen control characters 626, 628. The end of message character 624 for the terminal screen or printer reply data blocks 620 indicates either “middle” or “last” and/or “only” message of a reply. The screen control characters 626, 628 are utilized by a terminal screen distributed application 124 to determine screen placement and behavior for the terminal screen data 622.

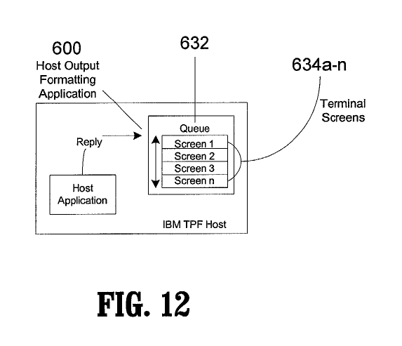

FIG. 12 is a block diagram illustration of the native terminal screen reply message transfer process between a host application 108 and a distributed application 128. A host output formatting application 630 has already received a reply message from the host application 108 and placed the reply message into the terminal message queue 632. The reply message may consist of multiple terminal screens 634a-n. The host output formatting application 630 sends the first terminal screen 634a to the distributed application 128 as a reply message to the terminal screen request message. Subsequent terminal screens 634b-n are sent to the distributed application 128 as reply messages to additional terminal screen request messages querying for the additional terminal screens 634b-n.

FIG. 13 illustrates native terminal screen or printer request and reply messages 640 that are transferred between a distributed application 128 and the distributed computer program interface 132. A reply message 640 consists of terminal screen or printer data 642 represented as ASCII characters, a record sequence indicator 644, two screen control characters 646, 648, and a data length indicator 649. The record sequence indicator 644 indicates “middle”, “last”, and/or “only” request or reply message 640. The screen control characters 646, 648 are only valid for terminal screen reply messages 640 and are utilized by a terminal screen distributed application 124 to determine screen placement and behavior for the terminal screen data 642.

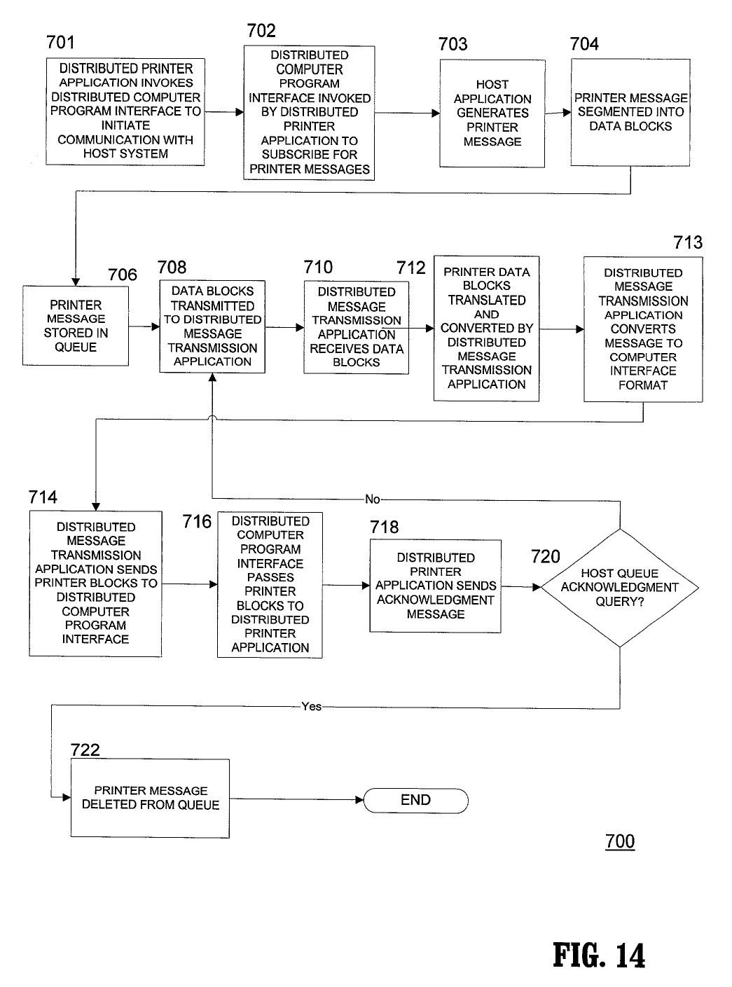

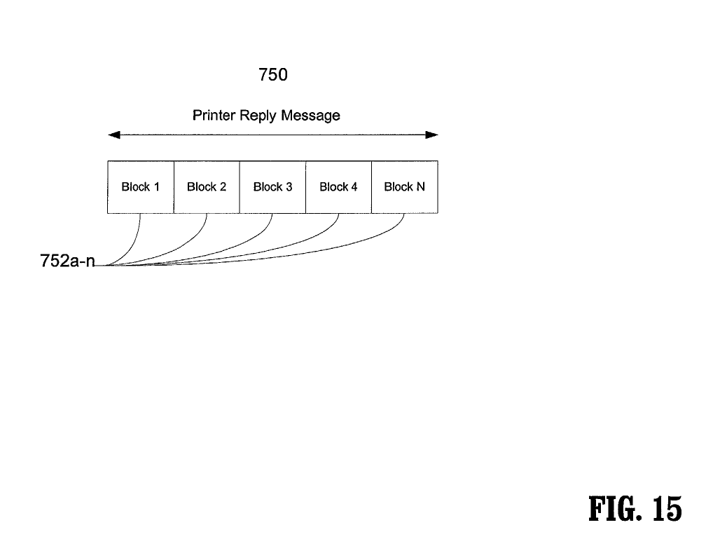

FIG. 14 is a logic flow diagram illustrating an exemplary process 700 for exchanging an electronic message in native printer format between a host computer system 102 and a distributed printer application 130. FIG. 15 illustrates a printer reply message 750 which may be any number of characters and may consist of multiple native TPF host printer data blocks 702a-n. It will be apparent to those skilled in the art that, although such messages are one-way messages from the host computer system 102 to a distributed printer application 130, they can be initiated by a host application 108 or alternatively, initiated by a separate distributed application 128 as a native terminal request/reply sequence that instructs the host application 108 to construct a printer message 750 from the currently queued terminal screen message and send the printer message 750 to a terminal printer 131 attached to the distributed computer workstation 122. Thus, in step 701, a distributed printer application 128 invokes the distributed computer program interface 132, utilizing the “create” program function, to initiate a messaging session with the TPF host computer system 102. The distributed printer application 130 specifies a text-based session name in the “create” program function, which the distributed computer program interface 132 utilizes to access a configuration file, located within the distributed computer workstation 122, with configuration details about the host messaging session. The configuration details of the host messaging session include information pertaining to the specific host resource such as a designation for a native TPF host computer system 102 printer messaging session, how the messaging session maps to a communication network resource, and details on creating communication connections between the distributed computer program interface 132 and the distributed message transmission application 124, and also between the communication network connection device and the distributed message transmission application 124. In step 702, the distributed printer application 130 invokes the distributed computer program interface 132, utilizing the “subscribe” program function, to begin receiving one-way native printer reply messages from the TPF host computer system 102.

In step 703, a host application 108 generates a printer reply message 750. In step 704, the printer reply message 750 is segmented into multiple native TPF host printer reply data blocks 620 if the printer reply message size exceeds the maximum transmission block size on the communication network 106. In step 706, the data blocks are stored in a host printer queue 120. In step 708, a copy of each of the data blocks 620 are sequentially transmitted to the distributed message transmission application 124 across the communications network 106. The data blocks 620 are in native TPF host printer format, i.e., EBCDIC message data characters 622, an end of message character 624 and two screen control characters 626, 628. This format is the same as native terminal screen reply message data blocks as shown in FIG. 11B.

In step 710, the distributed message transmission application 124 receives each of the data blocks 620 of the printer reply message 750. In step 712, the distributed message transmission application 124 translates the EBCDIC message data 622 to ASCII format and converts the end of message character 624 to a record sequence indicator 644. In step 713, the distributed message transmission application 124 converts the message data into a format acceptable to the distributed computer program interface 132. The conversion step involves adding a command character 310 to the front of the reply message, which informs the distributed computer program interface 132 that this is a native printer reply message, and adding a total length indicator 309 to the front of the request message to represent the total length of the transmission to the distributed computer program interface 132. In step 714, the distributed message transmission application 124 sends the reformatted printer data blocks 620 to the distributed computer program interface 132. In step 716, the distributed computer program interface 132 passes the printer reply message 640 to the distributed printer application 131. In step 718, the distributed printer application 131 generates and sends a one-way acknowledgment message to the host computer system 102, containing only a “middle” message record sequence indicator 644, via the distributed computer program interface 132 and the distributed message transmission application 124.

In step 720, the host printer queue 120 queries for the receipt of the acknowledgment from the distributed printer application 130. In step 722, if an acknowledgment is received, the exemplary process 700 deletes the printer data block 620 from the printer queue 120 and then returns to step 708 until there are no remaining printer data blocks 620 in the printer queue 120. If no acknowledgment is received in step 720, the exemplary process returns to step 708 and the host printer queue 120 resends the previous printer data block 620 repeatedly for a pre-selected period of time or until an acknowledgment is received.

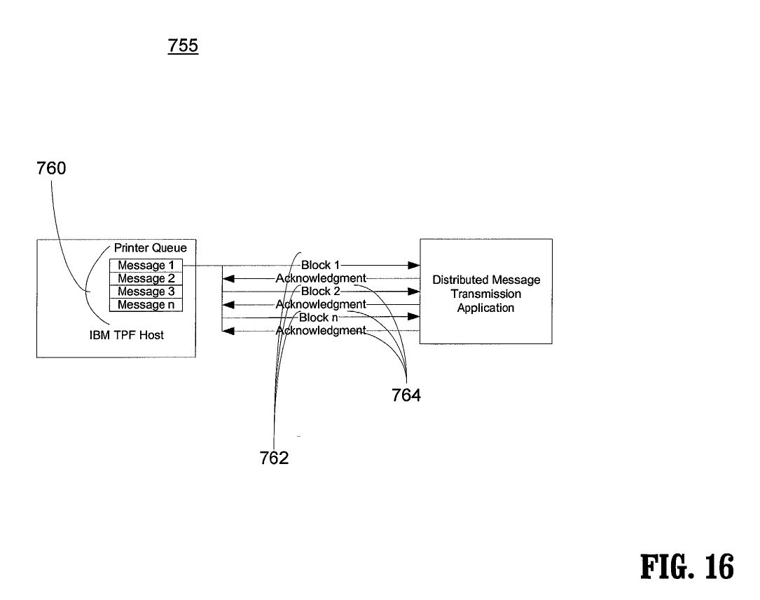

FIG. 16 is a block diagram illustration of a printer data block transfer process 755 between the host computer system 102 and the distributed message transmission application 124. In this instance, a host application 108 has already generated a printer reply message 750, which has been stored in the host printer queue 760. The host printer queue 760 disassembles the printer reply message 750 into a number of data blocks 762, which are then transmitted over the communications network 106 to the distributed message transmission application 124. Once the distributed message transmission application 124 has received a data block 762, it passes it to the distributed computer program interface 132 and then to the distributed printer application 130. The distributed printer application 130 then generates and sends an acknowledgment message 764 to the host printer queue 760. The process 755 is repeated for each data block 762 of the printer reply message 750.

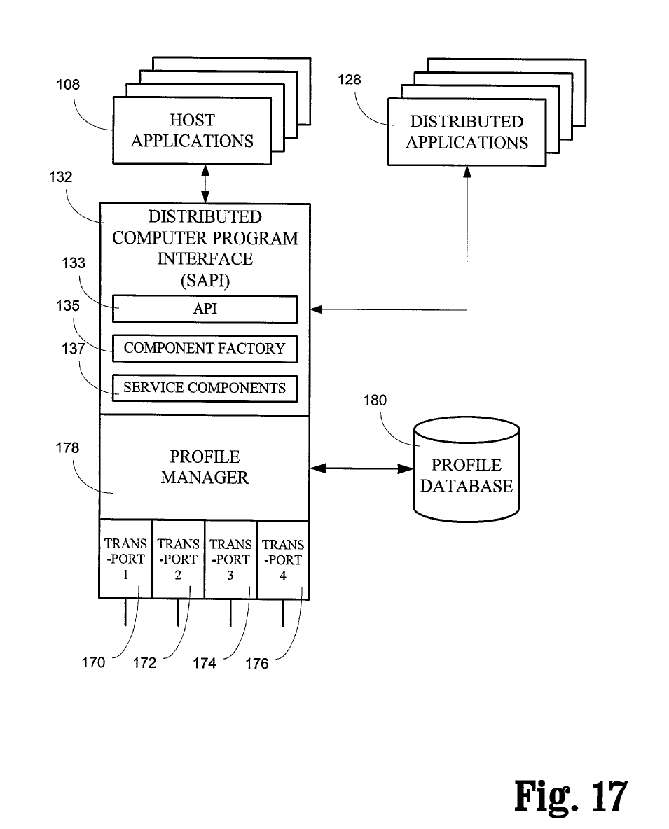

As described in connection with FIG. 1, the distributed message transmission application 124 may be attached to each of the other distributed applications 128 through individual communication connections to multiple instances of the distributed computer program interface 132 built into each distributed application 128. FIG. 17 is a functional block diagram depicting the architecture and components of the distributed computer program interface 132 of an exemplary embodiment of the present invention. The host application 108 communicates with the distributed computer program interface as described above in connection with FIGS. 1 and 16. Similarly, the distributed application 128 also can communicate with the distributed computer program interface 132. Either the host application 108 or the distributed application 128 may create a communication connection for transmitting and processing messages by invoking the distributed computer program interface 132.

An application 108, 128 may access the functionality of the distributed computer program interface 132 by transmitting a program function message to the distributed computer program interface. A program function message is recognized by the application programming interface 133. The use of an application programming interface (API) 133 is a well-known means for recognizing and processing program function messages or calls. In an exemplary embodiment of the present invention, the API 133 can be configured to recognize only a relatively small number of program function messages. This set of program function messages can be referred to as a verb list. Minimizing the verb list can optimize the efficiency of the distributed computer program interface, by minimizing the time and resources required to recognizing and process a given program function message.

As described above in connection with FIG. 1, the distributed message transmission application 124 may be attached to the communication network 106 through communication connections to communication network connection devices in the network. These communication network connection devices are commonly referred to as transports 170-176. The transports are responsible for, among other things, concentrating messages from many distributed computer workstation 122 onto higher capacity communication connections with the host computer system 102. Each transport 170-176 can have its own unique set of functions that are particularly useful for certain types of messages and/or certain types of communications between a distributed computer system workstation 122 and a host computer system 102.

A host application 108 or a distributed application 128 may require the use of a particular transport 170-176 given a certain set of conditions and may require the use of a second transport given a second set of conditions. To accommodate this, an exemplary embodiment of the present invention also includes a profile manager 178 that can operate in conjunction with a profile database 180 to coordinate the operations of the distributed computer program interface 132 and the transport 170-176. Specifically, the profile manager can determine certain characteristics of a message and can access the profile database 180 to determine how the message should be processed for transmission and which transport to use. The profile database 180 could be implemented as a multidimensional table from which the profile manager 178 can look up the relevant data with reference to the determined characteristics of the subject message. Accordingly, the appropriate transport and other message processing information can be determined for a particular message.

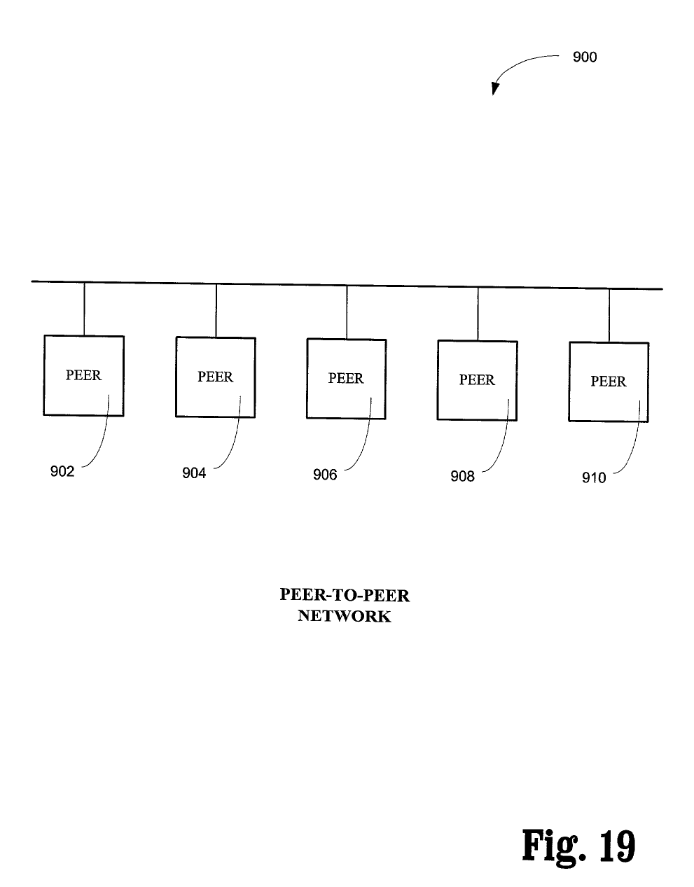

Advantageously, the transports 170-176 can be changed, removed, or added without requiring a corresponding change in any applications 108, 128. Similarly, if a policy decision is made as to the processing of a particular message, that policy decision can be implemented in the form of a modification of the profile database 180 rather than requiring a modification to one or more applications 108, 128. Accordingly, the profile manager 178 and profile database 180 operate as middleware to facilitate the processing of messages by the distributed computer program interface 132 in coordination with the transports 170-176. The various forms of message processing that are performed by the distributed computer program interface 132 (in conjunction with other network components), are often referred to as services. When an application 108, 128 transmits a message, a component factory 135 within the distributed computer program interface 132 is triggered to create a service component 137. The service component can identify the message contents and a service identifier. A service identifier is a text string or other data that can directly or indirectly identify the manner in which a message is to be routed to a receiving application. For example, a message may be routed to a receiving application as a request-reply format, a publish-subscribe format, or a send-and-forget format. These message formats are described below in more detail, in connection with FIGS. 19-25. The service identifier can be associated with a message by reference to a policy defined in the profile database 180. From the perspective of the sending application, the service identifier represents a routing address. In the case of an application that is transmitting a subscription request message, the service identifier can indicate the publishing service to which the sending application is subscribing.

Once the service component 137 has been created, the application can transmit the message using the appropriate transport 170-176, in the manner described above. In addition to service components 137, the component factory 135 can also generate an UTIL component for providing parsing and data processing functionality. The component factory can also create a fault tolerance component which functions to enable the monitoring of active and inactive applications for the purposes of determining which if any applications 108, 128 respond to a particularly message. Those skilled in the art would appreciate that various other components could be created by the component factory 135 to facilitate the processing and management of messages.

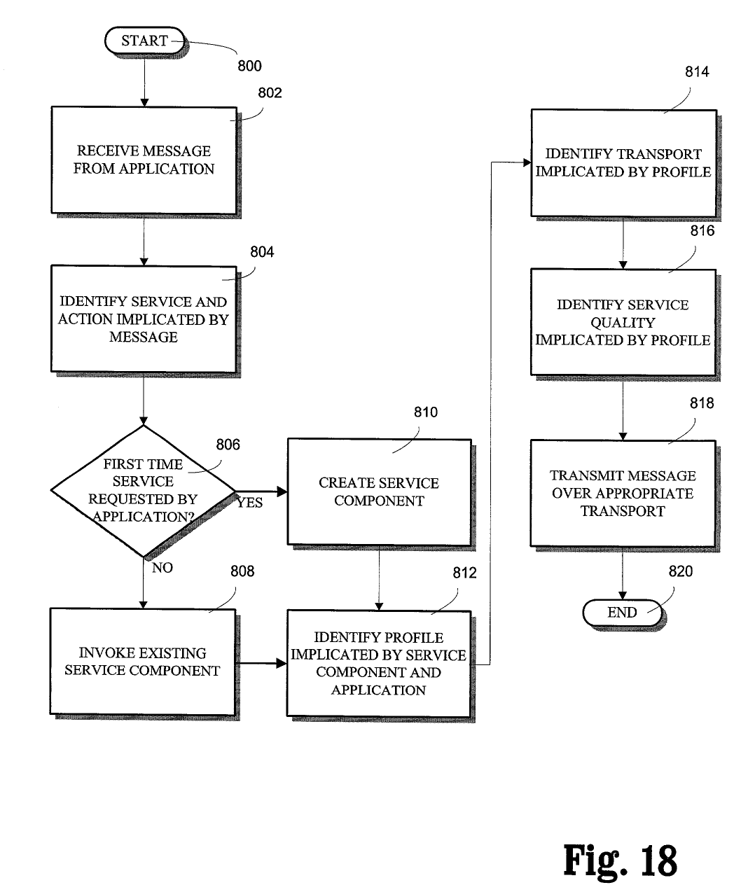

FIG. 18 is a flowchart depicting an exemplary process for processing a message received from an application. The method begins at decision block 800 and continues to step 802. At step 802, a message is received from an application. The method of FIG. 18 then proceeds to step 804. At step 804, the service and action implicated by the message is identified. In the exemplary embodiment described in connection with FIG. 17, the distributed computer interface can perform this step by examining a received message and extracting the information pertaining to service identification and to the desired message processing action.

The method of FIG. 18 proceeds from step 804 to decision block 806. At decision block 806, a determination is made as to whether the receipt of the message represents the first time that the service identified in the message was requested by the application. If it is determined that the service has been requested for the first time by the application, the method branches from decision block 806 to step 810. Step 810, a service component is generated that corresponds to the service identified in the message. If, on the other hand, it is determined at decision block 806 that the identified service has been previously requested by the application, the message branches to step 808. At step 808, an existing (i.e., previously created) service component is invoked for processing the received message. The method of FIG. 18 proceeds from step 808 to step 812. Notably, step 812 also can be reached from step 810. At step 812, the profile that is implicated by the service component and/or the application is identified. In the embodiment described in connection with FIG. 17, this step may be performed by the profile manager 178 in conjunction with the profile database 180. In any case, a profile associated with the characteristics of the message (e.g., relevant service component, relevant message processing action) can be used to identify and associate a profile with the received message. The method proceeds from step 812 to step 814.

At step 814, the transport implicated by the profile is identified. As described above in connection FIGS. 1 and 16, the transport is a network component for routing messages through a distributed computer system. Where multiple transports are used, the identification of the appropriate transport to be used for a particular message can be a significant step to proper message processing.

The method of FIG. 18 proceeds from step 814 to step 816. At step 816, the service implicated by the associated profile is identified. As described above in connection with FIG. 17, a profile associated with a received message can identify a service quality with which the message should be processed. The service quality is the level of protection to which a particular message is entitled. Among other things, the service quality can identify the transport to be used to transmit the message, whether the message is a guaranteed delivery message, and whether the message is encrypted. Those skilled in the art will appreciate that the higher the message service quality, the more costly the message transmission. Because an exemplary embodiment of the present invention enables the creation and modification of message processing policies, the costs of message transmission can be minimized by tailoring the service quality in, for example, a profile database. The method proceeds from step 816 to step 818, wherein the message is transmitted over the appropriate transport. The method then proceeds to end in the block 820 and terminates.

The method of FIG. 18, thus, processes a received message in accordance with a profile that is associated with that message. The appropriate profile may be determined by reference to one or more characteristics of the message, such as the application sending the message, the message contents, the services requested by the message, etc. The applicable profile can contain information as to what transport module can be used to transmit the message, what services apply to the message, and what service quality applies to the transmission of the message.

Advantageously, an exemplary embodiment of the present invention can be used to process messages generated by a variety of applications and using any number of distinct transports. An exemplary embodiment of the present invention is adaptive in that a message can be properly processed, even when an application and/or transport is changed or removed from the distributed computer system, by reference to an updated profile database. This adaptable versatility also makes the exemplary embodiments of the present invention very useful for processing messages, regardless of the structure of the distributed computer system. FIGS. 18-24 and the accompanying text provide a description of how exemplary embodiments of the present invention can be implemented in conjunction with various network structures and the function calls that are commonly used in those structures.

FIG. 19 is a block diagram depicting an exemplary peer-to-peer distributed computer network structure 900. In a peer-to-peer network structure 900, all of the distributed computers 902-910 in the network are similarly situated and there is no host computer system. All applications reside on the peer computers 902-910.

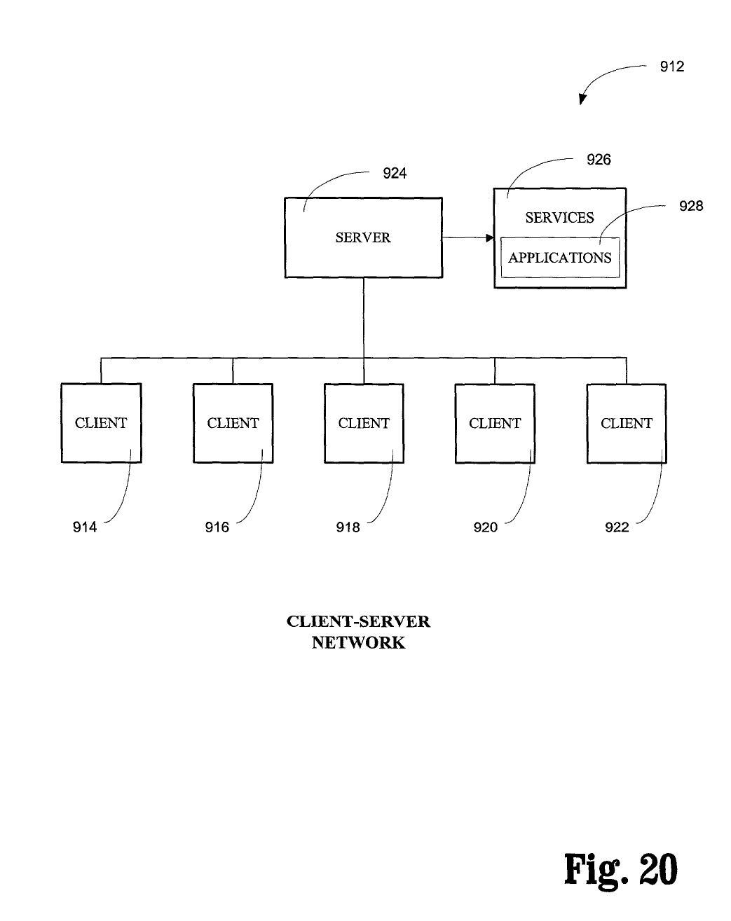

FIG. 20 is a block diagram depicting an exemplary client-server distributed computer network structure 912. In a client-server network structure 912, all of the distributed computers 914-922 in the network are similarly situated, but the distributed computer systems are connected to a host computer system, referred to as a server 924. The server 924 routes and processes messages transmitted between the server and each of the clients 914-922. The server also routes and processes messages transmitted between clients 914-922. Distributed applications (not shown) reside on the client computers. Host applications 928 may reside on the server 924 or may reside within a service module 926 that is functionally connected to the server. Briefly stated, a services module is a set of code or instructions that can be invoked when a message addressed to the module is transmitted. Such a message can be identified (i.e., associated with the services module) by reference to a service identifier that can sent as part of the message. Typically a services module receives a message as input and returns a responsive message as output.

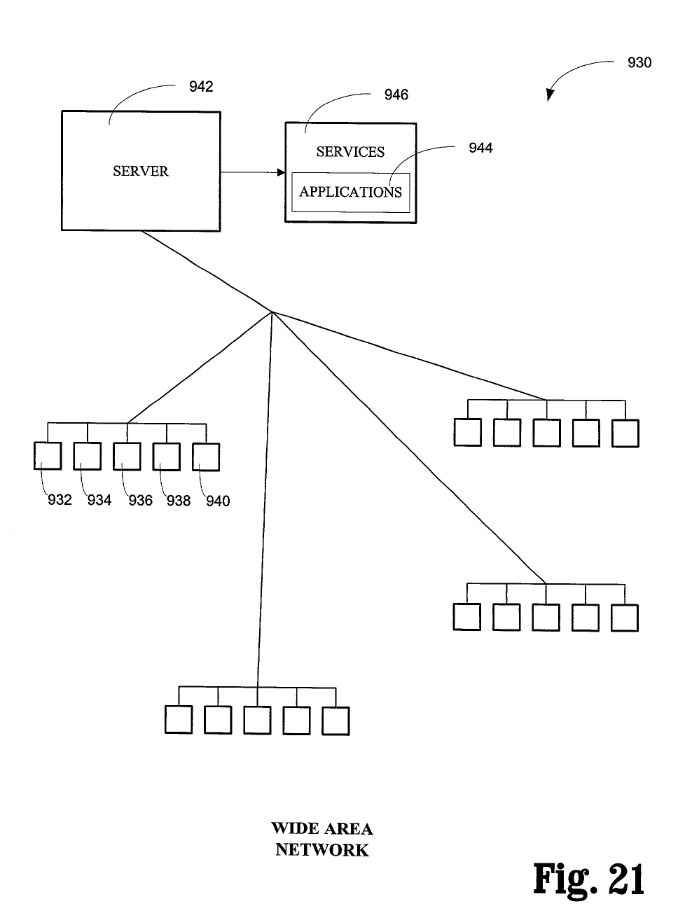

FIG. 21 is a block diagram depicting an exemplary wide area client-server distributed computer network structure 930. In a wide area client-server network structure 930, all of the distributed computers (e.g., 932-940) in the network are similarly situated, but the distributed computer systems are connected to a host computer system, referred to as a server 942. The server 942 routes and processes messages transmitted by the server to each of the clients. However, unlike the client-server network depicted in FIG. 20, there are typically too many client computers in the wide area network 930 to efficiently support client-to-server message transmissions or client-to-client message transmissions. Accordingly, the server 942 is typically used in the messaging context to broadcast messages over the network 930. Such broadcast messages are typically either received by all client computers or by those client computers that are subscribed to a particular service. A host application 944 may reside on the server 924 or may reside within a service module 946 that is functionally connected to the server.

Those skilled in the art will appreciate that various messaging techniques can be used in various circumstances, depending in part on the structure of the network in which the messaging is performed. For example, it would be inefficient or impossible for the server 942 to send a message to a specific client 932-940 and request confirmation of the receipt of the message and/or request a response from the client. On the other hand, it is quite common to send a message with a request for a response in a client-server network or a peer-to-peer network. FIGS. 21-24 depict various message processing services that can be implemented by an exemplary embodiment of the present invention in the context of various network structures described in connection with FIGS. 18-20.

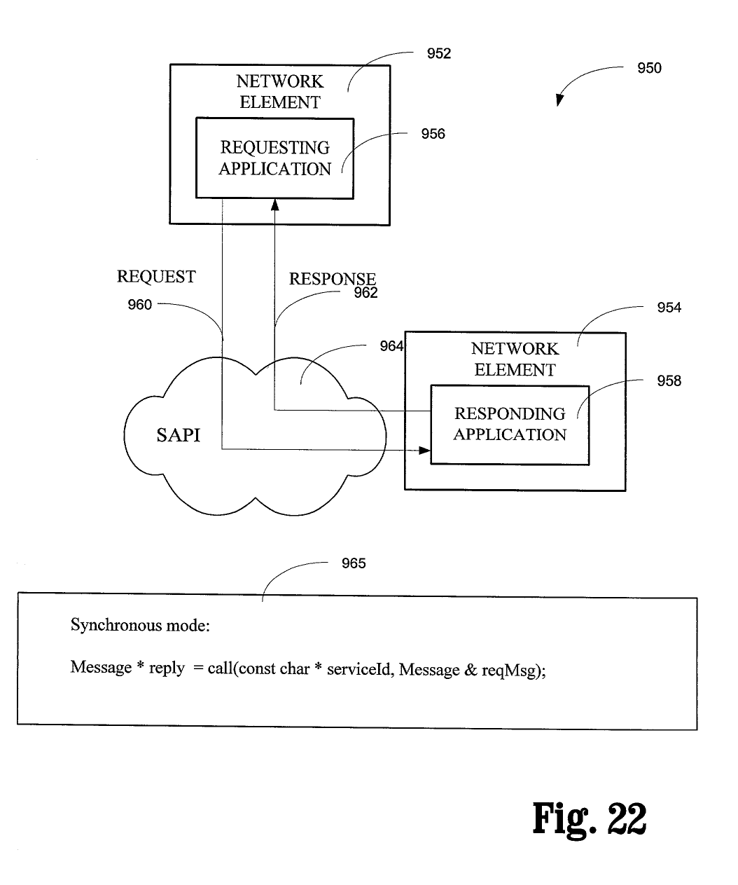

FIG. 22 is a block diagram depicting an exemplary synchronous reply requested message processing service 950. The network elements 952, 954 could be host/distributed computers operating in a network that can support the transmission of a reply message in response to a request. Such networks may include peer-to-peer networks, client-server networks, and wide area networks. In a peer-to-peer network or a client-server network, the reply request message can be sent to an application running on a particular network element (e.g., a host/server computer system) from an application running on another network element (e.g., a distributed/client computer system). In a synchronous mode of message processing, the system sending the reply request will typically force the requesting application to wait for the reply before executing other tasks. In a wide area network, the reply request message can be sent as a broadcast message by a publishing computer and received by all distributed computers that subscribe to the message service. Those distributed computers that are configured to respond to such a reply request (e.g., subscribers to the publishing service) will send reply messages to the requesting application on the publishing computer.

In the exemplary synchronous reply requested message processing service 950 depicted in FIG. 22, a first network element 952 is running a requesting application 956 and a second network element 954 is running a responding application 958. The network elements are connected through a distributed computer programming interface, also referred to as a Service Application Programming Interface (SAPI) 964. For the purposes of brevity, the other elements of the communication network are not depicted in FIG. 22. As described above, the SAPI 964 will translate the request 960 received from the requesting application 956 to a format that can be understood by the responding application 958. Likewise, the SAPI 964 will translate the reply 962 received from the responding application 958 to a format that can be understood by the requesting application 956. The synchronous mode reply request message 965 depicted in FIG. 22 provides an example of a typical reply request. The requesting application 956 transmitting this reply request will typically wait until a reply message 962 is received from the responding application 958 before proceeding to execute other functions.

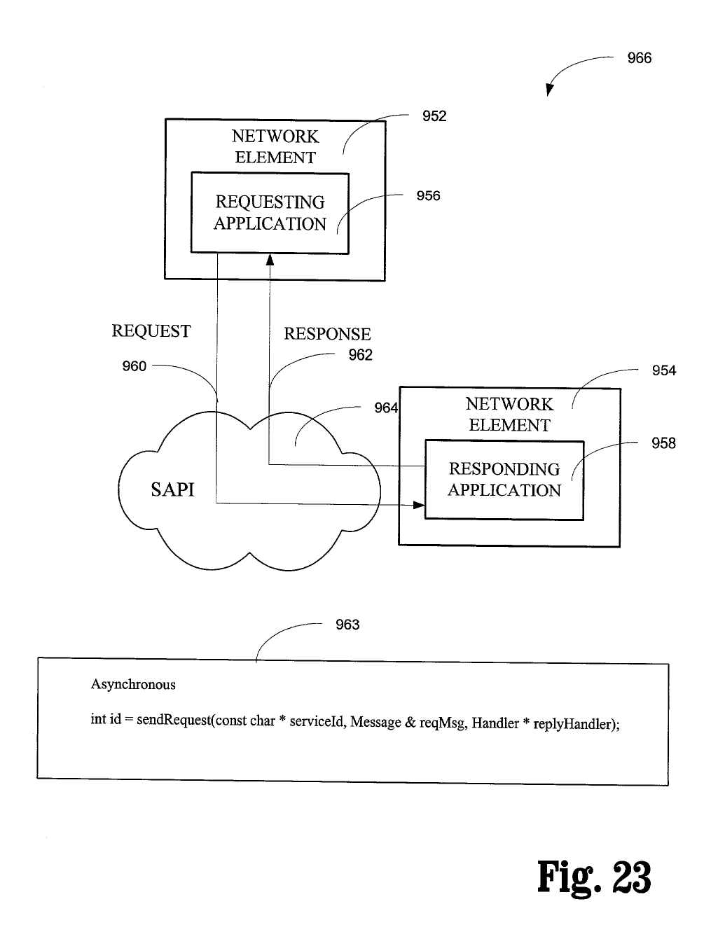

FIG. 23 is a block diagram depicting an exemplary asynchronous reply requested message processing service 966. As described in connection with FIG. 22, the network elements 952, 954 could be host/distributed computers operating in a network that can support the transmission of a reply message in response to a request. Such networks may include peer-to-peer networks, client-server networks, and wide area networks. In a peer-to-peer network or a client-server network, the reply request message can be sent to an application running on a particular network element (e.g., a host/server computer system) from an application running on another network element (e.g., a distributed/client computer system). In an asynchronous mode of message processing, the requesting application will not typically wait for the reply message before executing other tasks. On the contrary, the requesting application will typically invoke a handler application or “handle” (not shown) to manage the reply message and route it to the requesting application when it is transmitted from the responding application. In a wide area network, the reply request message can be sent as a broadcast message by a publishing computer and received by all distributed computers that subscribe to the message service. Those distributed computers that are configured to respond to such a reply request (e.g., subscribers to the publishing service) will send reply messages to the requesting application on the publishing computer.

In the exemplary asynchronous reply requested message processing service 966 depicted in FIG. 23, a first network element 952 is running a requesting application 956 and a second network element 954 is running a responding application 958. The network elements are connected through a distributed computer programming interface, also referred to as a Service Application Programming Interface (SAPI) 964. For the purposes of brevity, the other elements of the communication network are not depicted in FIG. 23. As described above, the SAPI 964 will translate the request 960 received from the requesting application 956 to a format that can be understood by the responding application 958. Likewise, the SAPI 964 will translate the reply 962 received from the responding application 958 to a format that can be understood by the requesting application 956. The asynchronous mode reply request message 963 depicted in FIG. 23 provides an example of a typical reply request. The requesting application 956 transmitting this reply request will not typically wait until a reply message 962 is received from the responding application 958 before proceeding to execute other functions. Indeed, a handler can be used to notify the requesting application 956 that a reply message has been generated by the responding application. In the reply request message 963 depicted in FIG. 23, the invoked handler is identified by the “replyHandler” argument.

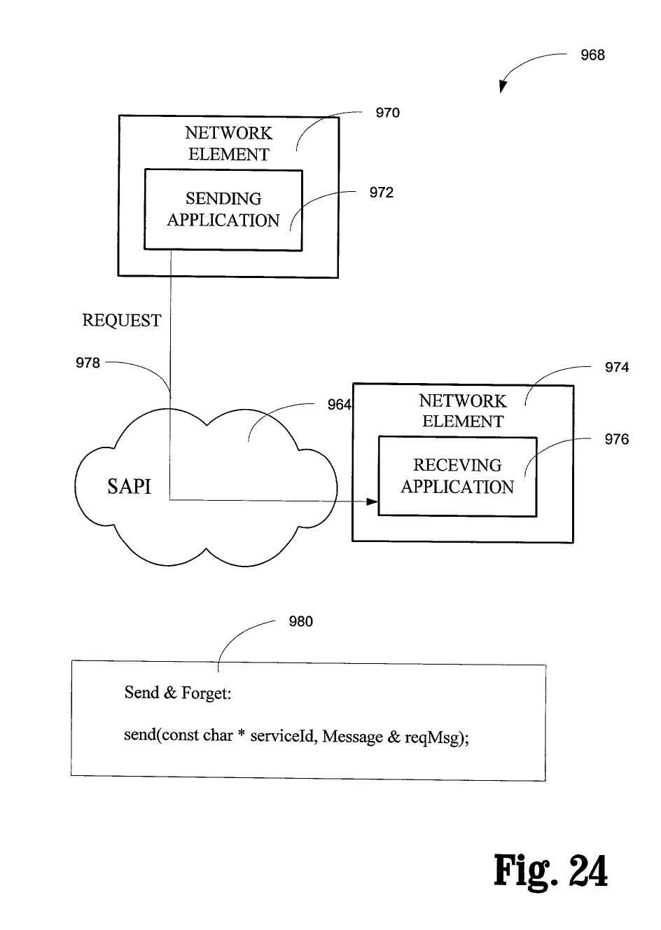

FIG. 24 is a block diagram depicting an exemplary send-and-forget message processing service. The send-and-forget message can be used in virtually any network structure. As described in connection with FIG. 22, the network elements 970, 974 could be host/distributed computers operating in a network that can support the transmission of messages. Such networks may include peer-to-peer networks, client-server networks, and wide area networks. In a peer-to-peer network or a client-server network, the send-and-forget message can be sent to an application running on a particular network element (e.g., a host/server computer system) from an application running on another network element (e.g., a distributed/client computer system). As indicated by the name, the send-and-forget message does not typically involve the request for or the generation of a responsive message. The send-and-forget message is particularly useful in a wide area network, where a response from the receiving applications is impossible or not particularly effective. Those distributed computers that are configured to receive such a send-and-forget message (e.g., subscribers to the publishing service) will process the received message, while those that are not configured to receive the message will ignore the message.

In the exemplary send-and-forget message processing service 968 depicted in FIG. 24, a first network element 970 is running a sending application 972 and a second network element 974 is running a receiving application 976. The network elements 970, 976 are connected through a distributed computer programming interface, also referred to as a Service Application Programming Interface (SAPI) 964. For the purposes of brevity, the other elements of the communication network are not depicted in FIG. 24. As described above, the SAPI 964 will translate the request 978 received from the sending application 972 to a format that can be understood by the responding application 976. The send-and-forget message 980 depicted in FIG. 24 is an example of this kind of message.

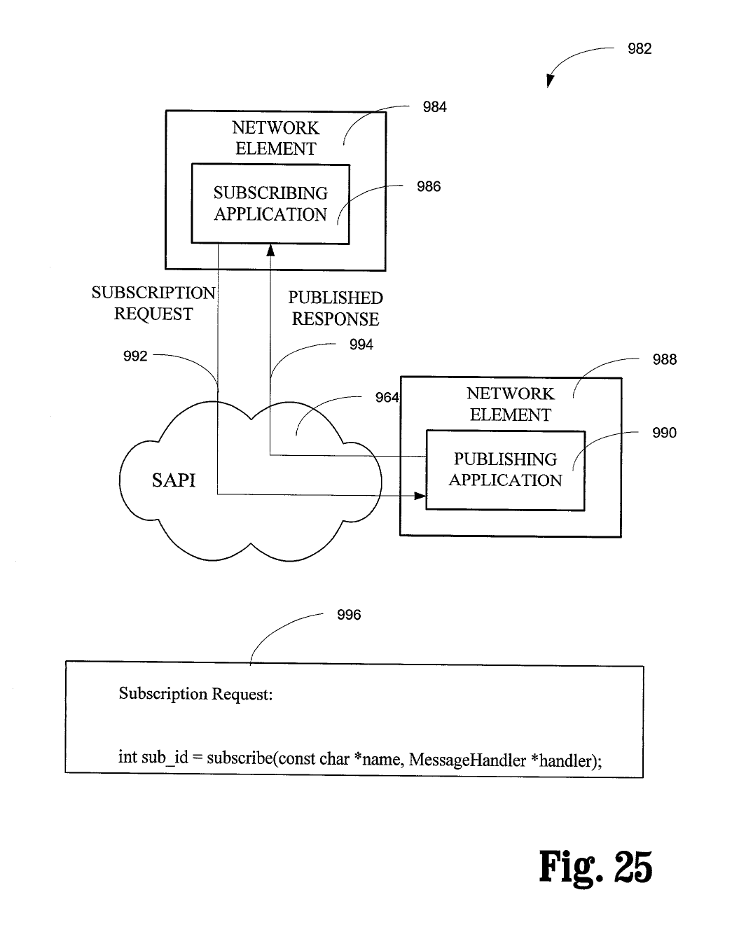

FIG. 25 is a block diagram depicting an exemplary publish-subscribe message processing service 982. The publish-subscribe message set can be used in virtually any network structure. As described in connection with FIG. 22, the network elements 984, 990 could be host/distributed computers operating in a network that can support the transmission of messages. Such networks may include peer-to-peer networks, client-server networks, and wide area networks. In a peer-to-peer network or a client-server network, the subscription request message 992 can be sent to an application running on a particular network element (e.g., a host/server computer system) from an application running on another network element (e.g., a distributed/client computer system). Likewise, the published response message 994 can be sent to an application running on a particular network element (e.g., a host/server computer system) from an application running on another network element (e.g., a distributed/client computer system). The publish-subscribe message set does not typically involve a targeted responsive message. That is, the publishing application does not typically identify a particular subscribing application that should receive the published response 994. On the contrary, the subscribing application 986 of a message handler will usually operate to identify the published response message and recognize that the published response message corresponds to a subscription message that the subscribing application transmitted previously. The publish-subscribe message is particularly useful in a wide area network, where a response from the receiving applications is impossible or not particularly effective. Those distributed computers that are configured to receive such a published message (e.g., subscribers to the publishing service) will process the received message, while those that are not configured to receive the message will ignore the message.

In the exemplary publish-subscribe message processing service 982 depicted in FIG. 25, a first network element 984 is running a subscribing application 986 and a second network element 988 is running a publishing application 990. The network elements 984, 988 are connected through a distributed computer programming interface, also referred to as a Service Application Programming Interface (SAPI) 964. For the purposes of brevity, the other elements of the communication network are not depicted in FIG. 25. As described above, the SAPI 964 will translate the subscription request 992 received from the subscribing application 986 to a format that can be understood by the publishing application 990. Likewise, the SAPI 964 will translate the published response message 994 received from the publishing application 990 to a format that can be understood by the subscribing application 986. The subscription request message 996 depicted in FIG. 25 is an example of this kind of message. The subscribing application 986 transmitting this subscription request will not typically wait until a published response message 994 is received from the publishing application 990 before proceeding to execute other functions. Indeed, a handler can be used to notify the subscribing application 986 that a published response message 994 has been generated by the publishing application 990. In the subscription request message 996 depicted in FIG. 25, the invoked handler is identified by the “MessageHandler” argument.

It will be appreciated that the present invention fulfills the needs of the conventional art described herein and meets the above-stated objects. While there has been shown and described the preferred embodiment of the invention, it will be evident to those skilled in the art that various modifications and changes may be made thereto without departing from the spirit and scope of the invention as set forth in the appended claims and equivalents thereof.

We claim:

1. A message processing system for transmitting and receiving messages between a host computer system application and a distributed computer system application, the message processing system comprising:
a distributed message transmission application associated with the distributed computer system application operative to process a message generated by the distributed computer system application, and to transmit the message to the host computer system application over the communication network;
a host system message transmission application associated with a host application and operative to process a message received from the distributed message transmission application; and
a distributed computer program interface functionally connected to the distributed computer system application and to the distributed message transmission application and operative to configure the message for transmission over a communication network.

2. The message processing system of claim 1, wherein the configuration of the message for transmission over the communication network comprises associating a transmission profile with the message.

3. The message processing system of claim 2, further comprising a distributed computer program interface that is operative to associate the message with a transmission profile stored in a profile database.

4. The message processing system of claim 3, wherein the distributed computer program interface comprises a profile manager operative to examine at least one characteristic of the message to determine the transmission profile to be associated with the message.

5. The message processing system of claim 4, wherein the message characteristic is an application identifier.

6. The message processing system of claim 4, wherein the message characteristic is a serial number.

7. The message processing system of claim 4, wherein the message characteristic is a record sequence indicator.

8. The message processing system of claim 4, wherein the message characteristic is an application data.

9. The message processing system of claim 4, wherein the message characteristic is a command character.

10. The message processing system of claim 4, wherein the communication network is a peer-to-peer network.

11. The message processing system of claim 4, wherein the communication network is a client-server network.

12. The message processing system of claim 4, wherein the communication network is a wide area client-server network.

13. The message processing system of claim 4, wherein the message is a request reply message.

14. The message processing system of claim 4, wherein the message is a send-and-forget message.

15. The message processing system of claim 4, wherein the message is a broadcast message.

16. The message processing system of claim 15, wherein the broadcast message is generated by a publishing service application and wherein the broadcast message is received by a subscribing network element.

17. A method for processing a message between a first application running on a first network element and a second application running on a second network element of a communication network, the method comprising the steps of:
generating the message in the first network element;
configuring the message for transmission over the communication network;
transmitting the message over the communication network; and
delivering the message to the second network element;
wherein the step of configuring the message for transmission comprises translating the message into a format associated with the second application.

18. The method of claim 17, wherein the step of configuring the message for transmission over the communication network comprises associating a transmission profile with the message.

19. The method of claim 18, wherein the step of configuring the message for transmission over the communication network comprises accessing a profile database to associate the transmission profile with the message.

20. The method of claim 19, wherein the step of configuring the message for transmission over the communication network comprises associating the transmission profile with the message, based on at least one message characteristic.

21. The method of claim 20, wherein the message characteristic is an application identifier

22. The method of claim 20, wherein the message characteristic is a serial number

23. The method of claim 20, wherein the message characteristic is a record sequence indicator

24. The method of claim 20, wherein the message characteristic is a application data

25. The method of claim 20, wherein the message characteristic is a command character

26. The method of claim 18, wherein the transmission profile comprises a transport identifier operative to associate the message with a transport to be used to transmit the message over the communication network.

27. The method of claim 18, wherein the transmission profile comprises a service identifier operative to associate the message with a message format to be used to transmit the message over the communication network.
